(19) United States
(12) Patent Application Publication
(10) Pub. No.: US 2022/0020082 A1
(43) Pub. Date: Jan. 20, 2022

(54) RENTAL INFORMATION GENERATION DEVICE, SECONDARY-BATTERY MANAGEMENT DEVICE, USER TERMINAL DEVICE, COMPUTER PROGRAM, AND RENTAL INFORMATION GENERATION METHOD

(71) Applicant: SUMITOMO ELECTRIC INDUSTRIES, LTD., Osaka-shi, Osaka (JP)

(72) Inventors: Tomomi KATAOKA, Osaka-shi (JP); Hiroaki TAKECHI, Osaka-shi (JP); Aoi HATANAKA, Osaka-shi (JP)

(73) Assignee: SUMITOMO ELECTRIC INDUSTRIES, LTD., Osaka-shi, Osaka (JP)

(21) Appl. No.: 17/295,326

(22) PCT Filed: Sep. 20, 2019
(86) PCT No.: PCT/JP2019/036942

§ 371 Date: May 19, 2021

(30) Foreign Application Priority Data
Dec. 4, 2018 (JP) 2018-227581

(51) Int. Cl. G06Q 30/06

(52) U.S. Cl. CPC G06Q 30/0645

(57) ABSTRACT

A rental information generation device includes: a requirement information acquisition unit configured to acquire requirement information of a user regarding use of an electric vehicle equipped with a secondary battery; a stock information acquisition unit configured to acquire stock information of objects including at least either one of a secondary battery and an electric vehicle; a decision unit configured to decide an object selection condition on the basis of the acquired requirement information and stock information; and a generation unit configured to generate rental information regarding an object to be rented out to the user on the basis of the decided selection condition.

### TECHNICAL FIELD

The present disclosure relates to a rental information generation device, a secondary-battery management device, a user terminal device, a computer program, and a rental information generation method.

This application claims priority on Japanese Patent Application No. 2018-227581 filed on Dec. 4, 2018, the entire content of which is incorporated herein by reference.

### BACKGROUND ART

In recent years, electric cars have been attracting attention due to environmental problems such as emission regulations. Since electric cars travel by using the energy supplied from batteries mounted thereon, the electric cars do not emit exhaust gas and are promising as a countermeasure against the environmental problems.

PATENT LITERATURE 1 discloses a car sharing system in which an electric car is shared by a plurality of users and which evenly distributes electric cars having relatively large remaining battery power in a plurality of parking lots to improve the operating rate of the electric cars.

### CITATION LIST

### Patent Literature

PATENT LITERATURE 1: Japanese Laid-Open Patent Publication No. 2016-130944

### SUMMARY OF INVENTION

A rental information generation device according to an embodiment of the present disclosure includes: a requirement information acquisition unit configured to acquire requirement information of a user regarding use of an electric vehicle equipped with a secondary battery; a stock information acquisition unit configured to acquire stock information of objects including at least either one of a secondary battery and an electric vehicle; a decision unit configured to decide an object selection condition on the basis of the acquired requirement information and stock information; and a generation unit configured to generate rental information regarding an object to be rented out to the user on the basis of the decided selection condition.

A secondary-battery management device according to an embodiment of the present disclosure includes a provision unit configured to provide specific information of a managed secondary battery to the above rental information generation device.

A user terminal device according to an embodiment of the present disclosure is a user terminal device including a display panel, the user terminal device including: a display unit configured to display requirement information regarding use of an electric vehicle equipped with a secondary battery, on the display panel; and an acceptance unit configured to accept a search operation based on the displayed requirement information, wherein, when the acceptance unit accepts the search operation, the display unit displays rental information regarding objects including at least either one of a secondary battery and an electric vehicle to be rented out to a user.

A computer program according to an embodiment of the present disclosure causes a computer to execute: a process of acquiring requirement information of a user regarding use of an electric vehicle equipped with a secondary battery; a process of acquiring stock information of objects including at least either one of a secondary battery and an electric vehicle; a process of deciding an object selection condition on the basis of the acquired requirement information and stock information; and a process of generating rental information regarding an object to be rented out to the user on the basis of the decided selection condition.

A computer program according to an embodiment of the present disclosure causes a computer to execute: a process of displaying requirement information regarding use of an electric vehicle equipped with a secondary battery, on a display panel; a process of accepting a search operation based on the displayed requirement information; and a process of, when the search operation is accepted, displaying rental information regarding objects including at least either one of a secondary battery and an electric vehicle to be rented out to a user.

A rental information generation method according to an embodiment of the present disclosure includes: acquiring requirement information of a user regarding use of an electric vehicle equipped with a secondary battery; acquiring stock information of objects including at least either one of a secondary battery and an electric vehicle; deciding an object selection condition on the basis of the acquired requirement information and stock information; and generating rental information regarding an object to be rented out to the user on the basis of the decided selection condition.

### BRIEF DESCRIPTION OF DRAWINGS

FIG. 1 is a schematic diagram showing an example of the configuration of a rental information generation system of a first embodiment.

FIG. 2 is a block diagram showing an example of the configuration of a user terminal device.

FIG. 3 is a block diagram showing an example of the configuration of an information generation server.

FIG. 4 is a block diagram showing an example of the configuration of a battery information management server.

FIG. 5 is a schematic diagram showing an example of flow of information in the case where a user owns a vehicle and rents a battery.

FIG. 6 is a schematic diagram showing an example of a use requirement.

FIG. 7 is a schematic diagram showing an example of the structure of a user information DB.

FIG. 8 is a schematic diagram showing an example of the structure of battery stock information.

FIG. 9 is a schematic diagram showing an example of the structure of battery management information.

FIG. 10 is a schematic diagram showing an example of battery rental information.

FIG. 11 is a flowchart showing an example of a process procedure of the information generation server in the case where a user owns a vehicle and rents a battery.

FIG. 12 is a flowchart showing the example of the process procedure of the information generation server in the case where a user owns a vehicle and rents a battery.

FIG. 13 is a schematic diagram showing an example of flow of information in the case where a user owns a battery and rents a vehicle.

FIG. 14 is a schematic diagram showing an example of the structure of vehicle stock information.

FIG. 15 is a schematic diagram showing an example of vehicle rental information.

FIG. 16 is a flowchart showing an example of a process procedure of the information generation server in the case where a user owns a battery and rents a vehicle.

FIG. 17 is a flowchart showing the example of the process procedure of the information generation server in the case where a user owns a battery and rents a vehicle.

FIG. 18 is a schematic diagram showing an example of flow of information in the case where a user rents both a vehicle and a battery.

FIG. 19 is a flowchart showing an example of a process procedure of the information generation server in the case where a user rents both a vehicle and a battery.

FIG. 20 is a flowchart showing the example of the process procedure of the information generation server in the case where a user rents both a vehicle and a battery.

FIG. 21 is a schematic diagram showing an example of the configuration of a rental information generation system of a second embodiment.

FIG. 22 is an explanatory diagram showing an example of battery operation by a battery asset operation service provider.

FIG. 23 is a schematic diagram showing an example of flow of information in the case where the battery asset operation service provider operates a battery owned by a user.

FIG. 24A is a schematic diagram showing an example of a screen displayed on a display panel of a user terminal device.

FIG. 24B is a schematic diagram showing an example of the screen displayed on the display panel of the user terminal device.

FIG. 24C is a schematic diagram showing an example of the screen displayed on the display panel of the user terminal device.

FIG. 24D is a schematic diagram showing an example of the screen displayed on the display panel of the user terminal device.

FIG. 24E is a schematic diagram showing an example of the screen displayed on the display panel of the user terminal device.

FIG. 24F is a schematic diagram showing an example of the screen displayed on the display panel of the user terminal device.

FIG. 25 is a schematic diagram showing an example of battery authentication by an information generation server.

### DESCRIPTION OF EMBODIMENTS

### [Problems to be Solved by the Present Disclosure]

The cost of purchasing and maintaining an electric car (also referred to as an electric vehicle) is high due to the soaring prices of battery materials, etc. Thus, the burden on the user can be reduced by using a sharing service. However, in the system of PATENT LITERATURE 1, it is not considered to provide an object to be rented out such as a battery mounted on an electric car or an electric car having a configuration that matches a user's request.

Therefore, an object of the present disclosure is to provide a rental information generation device, a secondary-battery management device, a user terminal device, a computer program, and a rental information generation method which can provide an object to be rented out corresponding to a user's request.

### [Effects of the Present Disclosure]

According to the present disclosure, an object to be rented out corresponding to a user's request can be provided.

### [Description of Embodiment of the Present Disclosure]

A rental information generation device according to the present embodiment includes: a requirement information acquisition unit configured to acquire requirement information of a user regarding use of an electric vehicle equipped with a secondary battery; a stock information acquisition unit configured to acquire stock information of objects including at least either one of a secondary battery and an electric vehicle; a decision unit configured to decide an object selection condition on the basis of the acquired requirement information and stock information; and a generation unit configured to generate rental information regarding an object to be rented out to the user on the basis of the decided selection condition.

A computer program according to the present embodiment causes a computer to execute: a process of acquiring requirement information of a user regarding use of an electric vehicle equipped with a secondary battery; a process of acquiring stock information of objects including at least either one of a secondary battery and an electric vehicle; a process of deciding an object selection condition on the basis of the acquired requirement information and stock information; and a process of generating rental information regarding an object to be rented out to the user on the basis of the decided selection condition.

A rental information generation method according to the present embodiment includes: acquiring requirement information of a user regarding use of an electric vehicle equipped with a secondary battery; acquiring stock information of objects including at least either one of a secondary battery and an electric vehicle; deciding an object selection condition on the basis of the acquired requirement information and stock information; and generating rental information regarding an object to be rented out to the user on the basis of the decided selection condition.

The requirement information acquisition unit acquires a user's use requirement (also referred to as use requirement) regarding use of an electric vehicle (also referred to as a vehicle) equipped with a secondary battery (also referred to as a battery or a battery pack). The requirement information includes a use content and an object to be rented. The use content includes s a use period, a destination, a visiting place, a stay period, the number of users, a budget, etc. The object to be rented indicates whether to rent only a secondary battery, only an electric vehicle, or both an electric vehicle and a secondary battery. When the object to be rented includes an electric vehicle, the requirement information can include a vehicle model, a model year, a vehicle body color, etc. When the object to be rented includes a secondary battery, cost precedence or traveling time precedence can be selected by the requirement information.

The stock information acquisition unit acquires stock information of objects including at least either one of a secondary battery and an electric vehicle. The stock information can include an identification number for identifying each object, reservation status/availability information and a use fee of each object, etc.

The decision unit decides an object selection condition on the basis of the acquired requirement information and stock information. The selection condition is a condition for narrowing down objects that meet the requirement information, from stored objects.

The generation unit generates rental information regarding an object to be rented out to a user, on the basis of the decided selection condition. The rental information can include an identification number for identifying the object, a use period (rental period), a use fee, etc. The object identified by the rental information can be delivered to the user, and the user can use the object.

With the above configuration, the user can rent and use an object that meets requirement information, merely by presenting the requirement information, so that an object to be rented out corresponding to the user's request can be provided.

The rental information generation device according to the present embodiment includes a possession information acquisition unit configured to acquire vehicle information of an electric vehicle owned by the user, the stock information acquisition unit acquires secondary battery stock information, the decision unit decides a secondary battery selection condition on the basis of the requirement information, and the acquired vehicle information and secondary battery stock information, and the generation unit generates rental information regarding a secondary battery to be rented out to the user.

The possession information acquisition unit acquires vehicle information of an electric vehicle owned by a user. In this case, the user rents a secondary battery to be mounted to the electric vehicle owned by the user. The vehicle information can include an identification number for identifying the electric vehicle.

The stock information acquisition unit acquires secondary battery stock information.

The decision unit decides a secondary battery selection condition on the basis of the requirement information, and the acquired vehicle information and secondary battery stock information. The selection condition is a condition for narrowing down secondary batteries that meet the requirement information and match the electric vehicle owned by the user, from stored secondary batteries.

The generation unit generates rental information regarding the secondary battery to be rented out to the user. The rental information can include an identification number for identifying the secondary battery, a use period (rental period), a use fee, etc. The secondary battery identified by the rental information can be delivered to the user, and the user can mount the secondary battery to the electric vehicle and use the electric vehicle.

With the above configuration, the user can rent and use a secondary battery that meets requirement information, merely by presenting the requirement information, so that a secondary battery that matches the electric vehicle owned by the user and the user's own request can be easily selected.

The rental information generation device according to the present embodiment includes a possession information acquisition unit configured to acquire battery information of a secondary battery owned by the user, the stock information acquisition unit acquires electric vehicle stock information, the decision unit decides an electric vehicle selection condition on the basis of the requirement information, and the acquired battery information and electric vehicle stock information, and the generation unit generates rental information regarding an electric vehicle to be rented out to the user.

The possession information acquisition unit acquires battery information of a secondary battery owned by a user. In this case, the user rents an electric vehicle on which all or part of the battery owned by the user is mounted. The battery information can include an identification number for identifying the secondary battery.

The stock information acquisition unit acquires electric vehicle stock information.

The decision unit decides an electric vehicle selection condition on the basis of the requirement information, and the acquired battery information and electric vehicle stock information. The selection condition is a condition for narrowing down electric vehicles that meet the requirement information and match the secondary battery owned by the user, from stored electric vehicles.

The generation unit generates rental information regarding the electric vehicle to be rented out to the user. The rental information can include an identification number for identifying the electric vehicle, a use period (rental period), a use fee, etc. The electric vehicle identified by the rental information can be delivered to the user, and the user can mount the secondary battery owned by the user, to the electric vehicle and use the electric vehicle.

With the above configuration, the user can rent and use a vehicle that meets requirement information, merely by presenting the requirement information, so that an electric vehicle that matches the secondary battery owned by the user and the user's own request can be easily selected.

In the rental information generation device according to the present embodiment, the stock information acquisition unit acquires secondary battery and electric vehicle stock information, the decision unit decides secondary battery and electric vehicle selection conditions on the basis of the requirement information and the acquired secondary battery and electric vehicle stock information, and the generation unit generates rental information regarding a secondary battery and an electric vehicle to be rented out to the user.

The stock information acquisition unit acquires secondary battery and electric vehicle stock information. In this case, the user rents both an electric vehicle and a secondary battery.

The decision unit decides secondary battery and electric vehicle selection conditions on the basis of the requirement information, and the acquired secondary battery and electric vehicle stock information. The selection conditions are conditions for narrowing down electric vehicles and secondary batteries that meet the requirement information, from stored electric vehicles and secondary batteries.

The generation unit generates rental information regarding the secondary battery and the electric vehicle to be rented out to the user. The rental information can include identification numbers for identifying the electric vehicle and the secondary battery, respectively, a use period (rental period), a use fee, etc. The electric vehicle and the secondary battery identified by the rental information are delivered to a predetermined place, work for mounting the secondary battery to the electric vehicle is performed, and the electric vehicle having the secondary battery mounted thereon is delivered to the user. The user can use the electric vehicle immediately.

With the above configuration, the user can rent and use an electric vehicle on which a secondary battery that meets requirement information is mounted, merely by presenting the requirement information, so that combination of an electric vehicle and a secondary battery that match the user's own request can be easily selected.

In the rental information generation device according to the present embodiment, the decision unit decides a selection condition for a combination of a secondary battery and an electric vehicle on the basis of the requirement information and the acquired secondary battery and electric vehicle stock information.

The decision unit decides a selection condition for a combination of a secondary battery and an electric vehicle on the basis of the requirement information and the acquired secondary battery and electric vehicle stock information. When a secondary battery selection condition and an electric vehicle selection condition are decided independently, for example, whereas a condition that a heavy electric vehicle is selected may be decided, a condition that a secondary battery that tends to consume power is selected may be decided. In such a case, the distance for which the electric vehicle can travel becomes shorter, which is not preferable. Therefore, for example, a selection condition is decided for a combination of a secondary battery and an electric vehicle such that a secondary battery having a capacity corresponding to the weight of an electric vehicle can be selected. Accordingly, a combination of a secondary battery and an electric vehicle that meet the requirement information can be determined from the stored electric vehicles and secondary batteries.

In the rental information generation device according to the present embodiment, the requirement information acquisition unit acquires requirement information including a use date of an electric vehicle and a destination, the rental information generation device further comprises a route estimation unit configured to estimate a traveling route on the basis of the acquired use date and destination, and the decision unit decides an object selection condition on the basis of the estimated traveling route.

The requirement information acquisition unit acquires requirement information including a use date of an electric vehicle and a destination. The use date includes, for example, a use start date and a use end date (that is, a use period). The destination is not limited to one, and can include a plurality of destinations to be visited during the use days.

The route estimation unit estimates a traveling route on the basis of the acquired use date and destination. As for the traveling route, traffic jams in the use period may be predicted, and a traveling route that avoids the traffic jams may be estimated, or a traveling route with a short traveling distance may be estimated, or a traveling route with a short traveling time (through which the destination can be reached earliest) may be estimated,), or a traveling route with a better electric mileage may be estimated. The traveling route can be estimated according to the user's requirement information.

The decision unit decides an object selection condition on the basis of the estimated traveling route. For example, when renting out a secondary battery as an object, the full charge capacity of a secondary battery can be selected on the basis of the traveling route. In addition, when renting out an electric vehicle as an object, the size or vehicle model of an electric vehicle can be selected on the basis of the traveling route.

With the above configuration, more specific traveling route information can be extracted from the requirement information presented by the user, the implicit request of the user based on the viewpoint of traveling route can be grasped, and an object to be rented out that further matches the user' request can be provided.

The rental information generation device according to the present embodiment includes: a consumption estimation unit configured to estimate a power consumption of a secondary battery on the basis of the acquired requirement information and the estimated traveling route; a specific information acquisition unit configured to acquire specific information including an SOC of the secondary battery; and a charging plan generation unit configured to generate a charging plan for the secondary battery on the basis of the estimated power consumption and the acquired specific information.

The consumption estimation unit estimates a power consumption of a secondary battery on the basis of the acquired requirement information and the estimated traveling route. For example, the consumption estimation unit estimates the amount of power consumed by the secondary battery when the electric vehicle is used in the period from the use start date to the use end date.

The specific information acquisition unit acquires specific information including the SOC of the secondary battery (for example, the secondary battery to be rented out to the user). The specific information may be acquired from the secondary battery stock information, or may be acquired from a device such as a battery information management server that manages the secondary battery information.

The charging plan generation unit generates a secondary battery charging plan on the basis of the estimated power consumption and the acquired specific information. For example, when the use of the electric vehicle is started, the SOC of the secondary battery mounted on the electric vehicle is obtained, and whether it is necessary to charge the secondary battery before the start of use, is determined in accordance with whether the SOC of the secondary battery becomes less than a lower limit before the end of use. When charging is necessary, a charging plan can be generated. Accordingly, it is not necessary to charge the secondary battery during use of the electric vehicle, so that the convenience of the user can be improved.

In the rental information generation device according to the present embodiment, when a voltage difference between a plurality of secondary batteries is larger than a predetermined threshold, the charging plan generation unit generates a charging plan that equalizes voltages of the plurality of secondary batteries.

When the voltage difference between the plurality of secondary batteries is larger than the predetermined threshold, the charging plan generation unit generates a charging plan that equalizes the voltages of the plurality of secondary batteries.

For example, when secondary batteries having different capacities, battery characteristics, or the like, are mounted together on one electric vehicle, the voltage difference between the multiple secondary batteries may become larger than the predetermined threshold. If the secondary batteries are mounted together (for example, connected in parallel) in such a state, an excessive current flows between the multiple secondary batteries, resulting in deterioration of the secondary batteries. The voltages may be equalized, for example, by charging a secondary battery having a lower voltage to increase the voltage.

As described above, for example, a secondary battery having a lower voltage is charged such that the voltage difference between the multiple secondary batteries becomes equal to or less than the predetermined threshold. Accordingly, different secondary batteries can be mounted together to the electric vehicle, and deterioration of the secondary batteries can be suppressed.

The rental information generation device according to the present embodiment includes: a consumption estimation unit configured to estimate a power consumption of a secondary battery on the basis of the acquired requirement information and the estimated traveling route; and a necessity determination unit configured to determine whether charging or replacement of the secondary battery in a middle of the traveling route is necessary, on the basis of the estimated power consumption.

The consumption estimation unit estimates a power consumption of a secondary battery on the basis of the acquired requirement information and the estimated traveling route. For example, the consumption estimation unit estimates the amount of power consumed by the secondary battery when the electric vehicle is used in the period from the use start date to the use end date.

The necessity determination unit determines whether charging or replacement of the secondary battery in the middle of the traveling route is necessary, on the basis of the estimated power consumption. Such necessity determination can be performed, for example, on the basis of whether the estimated power consumption is larger than the full charge capacity of the secondary battery. Accordingly, a plan for secondary battery replacement or charging to be required during use of the electric vehicle is generated in advance, and thus a situation in which the electric vehicle becomes unable to travel while the user is using the electric vehicle can be prevented.

The rental information generation device according to the present embodiment includes a condition acquisition unit configured to acquire a condition regarding operation of a secondary battery owned by another user different from the user, and the generation unit generates rental information regarding the secondary battery to be operated on the basis of the condition.

The condition acquisition unit acquires a condition regarding operation of a secondary battery owned by another user different from the user. The other user can entrust the secondary battery owned by the other user, to a battery asset operation service provider, and request the operation (maintenance, renting-out to another user, etc.) of the secondary battery.

The generation unit generates rental information regarding the secondary battery to be operated on the basis of the condition. Accordingly, the secondary battery owned by the other user can be provided to the user in accordance with the condition presented by the other user.

In the rental information generation device according to the present embodiment, the condition includes a first condition that requires a permission of the other user each time the secondary battery is rented out, a second condition that does not require a permission of the other user, and a third condition that does not permit the secondary battery to be rented out.

The condition includes a first condition that requires a permission of the other user each time the secondary battery is rented out, a second condition that does not require a permission of the other user, and a third condition that does not permit the secondary battery to be rented out. Accordingly, the number of options when the operation of the owned secondary battery is entrusted is increased, making it easier for the other user to entrust the operation of the secondary battery to the business operator.

The rental information generation device according to the present embodiment includes a transmission unit configured to transmit key information for a lock to a user terminal device in order to allow the lock to be opened when mounting a secondary battery to an electric vehicle.

The transmission unit transmits key information for the lock to the user terminal device in order to allow the lock to be opened when mounting a secondary battery to an electric vehicle (for example, electric vehicle to be rented-out). The user terminal device receives the key information. When the user carries the user terminal device that has received the key information, and approaches the lock, the lock can be opened, allowing the secondary battery to be mounted to the electric vehicle. Accordingly, unauthorized use of the object to be rented out can be prevented.

The rental information generation device according to the present embodiment includes: an identification information acquisition unit configured to acquire identification information of a secondary battery to be mounted to an electric vehicle; and an output unit configured to output verification information corresponding to the acquired identification information, to a verification unit provided in the electric vehicle, in order to register the verification information in the verification unit.

The identification information acquisition unit acquires identification information of a secondary battery to be mounted to an electric vehicle. For example, a chip including identification information (for example, serial number, etc.) is integrated with a secondary battery owned by a user.

The output unit outputs verification information corresponding to the acquired identification information, to a verification unit provided in the electric vehicle, in order to register the verification information in the verification unit. For example, when shipping an electric vehicle to be rented out, the verification information is registered in the verification unit of the electric vehicle. That is, verification information for verifying a secondary battery that is permitted to be used is registered in the electric vehicle in advance. Accordingly, unauthorized use of the object to be rented out can be prevented.

A secondary-battery management device according to the present embodiment includes a provision unit configured to provide specific information of a managed secondary battery to the above rental information generation device.

The secondary-battery management device can provide specific information of a managed secondary battery to the rental information generation device.

The secondary-battery management device according to the present embodiment includes an acquisition unit configured to acquire specific information of a secondary battery owned by a user.

The secondary-battery management device can acquire specific information of a secondary battery owned by a user and manage the specific information of the secondary battery owned by the user.

A user terminal device according to the present embodiment is a user terminal device including a display panel, the user terminal device including: a display unit configured to display requirement information regarding use of an electric vehicle equipped with a secondary battery, on the display panel; and an acceptance unit configured to accept a search operation based on the displayed requirement information, wherein, when the acceptance unit accepts the search operation, the display unit displays rental information regarding objects including at least either one of a secondary battery and an electric vehicle to be rented out to a user.

A computer program according to the present embodiment causes a computer to execute: a process of displaying requirement information regarding use of an electric vehicle equipped with a secondary battery, on a display panel; a process of accepting a search operation based on the displayed requirement information; and a process of, when the search operation is accepted, displaying rental information regarding objects including at least either one of a secondary battery and an electric vehicle to be rented out to a user.

The display unit displays requirement information regarding use of an electric vehicle equipped with a secondary battery, on the display panel. The requirement information may be inputted by the user, or may be selected from displayed information. When a search operation based on the displayed requirement information is accepted, the display unit displays rental information regarding objects including at least either a secondary battery or an electric vehicle to be rented out to the user.

Accordingly, when the user merely inputs or selects requirement information, an object that meets the requirement information is displayed, so that an object that matches the user's request can be easily selected.

In the user terminal device according to the present embodiment, the display unit displays an electric vehicle setting screen for setting a user's preference for an electric vehicle to be rented out to the user.

The display unit displays an electric vehicle setting screen for setting a user's preference for an electric vehicle to be rented out to the user. The user's preference for an electric vehicle includes, for example, a vehicle model, a model year, a vehicle body color, a capacity, a use fee, etc. Accordingly, an electric vehicle that matches the user's request can be easily selected.

In the user terminal device according to the present embodiment, the display unit displays a secondary battery setting screen for setting a user's preference for a secondary battery to be rented out to the user.

The display unit displays a secondary battery setting screen for setting a user's preference for a secondary battery to be rented out to the user. The user's preference for a secondary battery includes, for example, cost precedence, traveling time precedence, etc. Accordingly, a secondary battery that matches the user's request can be easily selected.

In the user terminal device according to the present embodiment, the display unit displays a selection screen for selecting a secondary battery to be mounted to an electric vehicle, from among a plurality of secondary batteries owned by the user.

The display unit displays a selection screen for selecting a secondary battery to be mounted to an electric vehicle, from among a plurality of secondary batteries owned by the user. For secondary battery selection, for example, a secondary battery owned by the user can be selected, or an entrusted secondary battery can be selected. In addition, it is possible to decide which location (for example, entrance, indoor, etc.) of a used secondary battery to be selected from among the owned secondary batteries. Moreover, it is possible to decide which current value of a secondary battery to be selected from among the entrusted secondary batteries. Accordingly, a secondary battery that matches the user's request can be easily selected.

### [Details of Embodiment of the Present Disclosure]

### (First Embodiment)

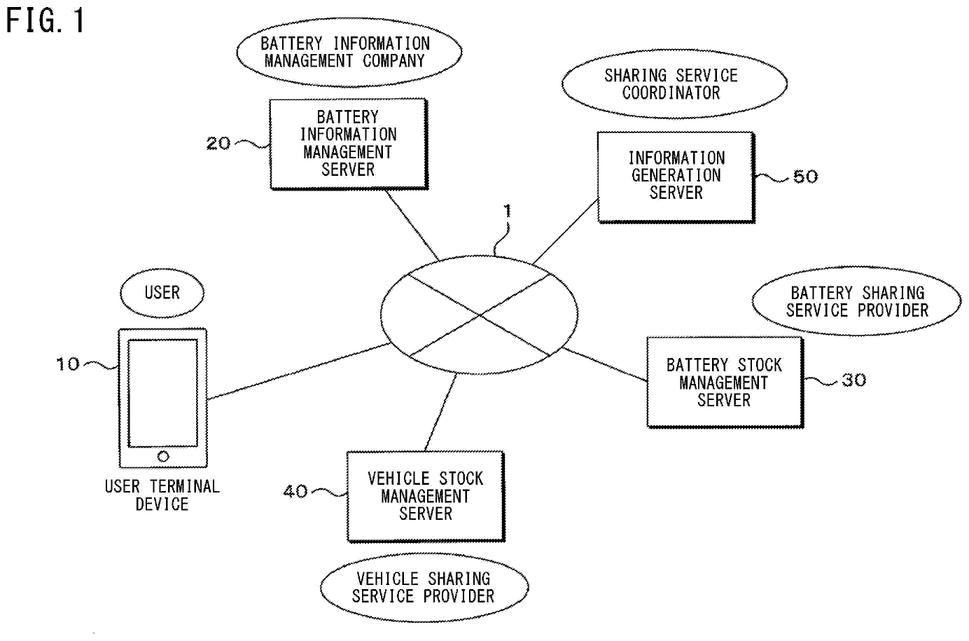

Hereinafter, the rental information generation device, the secondary-battery management device, and the user terminal device of the present embodiment will be described with reference to the drawings. FIG. 1 is a schematic diagram showing an example of the configuration of a rental information generation system of a first embodiment. The rental information generation system includes an information generation server 50 as a rental information generation device. The information generation server 50 is a server operated by a sharing service coordinator. The information generation server 50 is connected to a communication network 1 such as the internet.

A battery information management server 20 as a secondary-battery management device operated by a battery information management company is connected to the communication network 1, a battery stock management server 30 operated by a battery sharing service provider is connected to the communication network 1, and a vehicle stock management server 40 operated by a vehicle sharing service provider is connected to the communication network 1. In addition, a user terminal device 10 owned (carried) by a user is connected to the communication network 1. In the example of FIG. 1, only one user terminal device 10 is shown, but a plurality of user terminal devices 10 of respective users can be connected.

The sharing service coordinator provides a service of preparing a vehicle (also referred to as an electric vehicle or EV) stored and managed by the vehicle sharing service provider, or preparing a battery (also referred to as a battery pack or secondary battery) stored and managed by the battery sharing service provider, on the basis of a use requirement (also referred to as requirement information) presented by a user, and renting out (providing) at least either one of the prepared vehicle and battery (also referred to as objects) to the user.

The vehicle sharing service provider provides (rents out) a vehicle prepared on the basis of a vehicle selection condition presented by the sharing service coordinator, to the sharing service coordinator. The battery sharing service provider provides (rents out) a battery prepared on the basis of a battery selection condition presented by the sharing service coordinator, to the sharing service coordinator.

The battery information management company can trace a battery using a battery identification number, and, for example, can manage a distribution history of the battery after the battery is manufactured. More specifically, the battery information management company can grasp which vehicle the battery is mounted on or whether the battery is removed from a vehicle; when the battery is mounted on a vehicle, the battery information management company can grasp a vehicle identification number of the vehicle; and when the battery is removed from a vehicle, the battery information management company can grasp an identification number of the owner of the battery, etc.

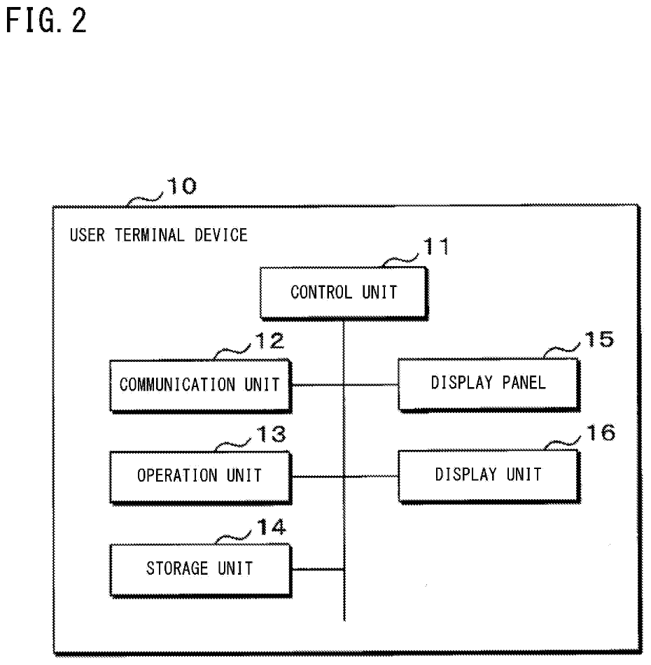

FIG. 2 is a block diagram showing an example of the configuration of the user terminal device 10. The user terminal device 10 is composed of, for example, a smartphone, a tablet, a notebook type personal computer, or the like. The user terminal device 10 includes a control unit 11 that controls the entire device, a communication unit 12, an operation unit 13, a storage unit 14, a display panel 15, and a display unit 16.

The control unit 11 can be composed of a CPU, a ROM, a RAM, and the like. The CPU includes a processor. Each process performed by the user terminal device 10 can be performed by the processor.

The communication unit 12 provides a function of communication with the information generation server 50 via the communication network 1.

The operation unit 13 is composed of a touch panel and the like. Using the operation unit 13, characters can be inputted, and operations on icons, buttons, menu bars, windows, cursors, etc., on the display panel 15 can be performed. The operation unit 13 may be composed of a keyboard, a mouse, and the like.

The storage unit 14 can store predetermined information therein. For example, information transmitted by the information generation server 50 can be received by the communication unit 12, and the received information can be stored in the storage unit 14.

The display unit 16 performs a process of displaying required information on the display panel 15. The details of the information displayed on the display panel 15 will be described later.

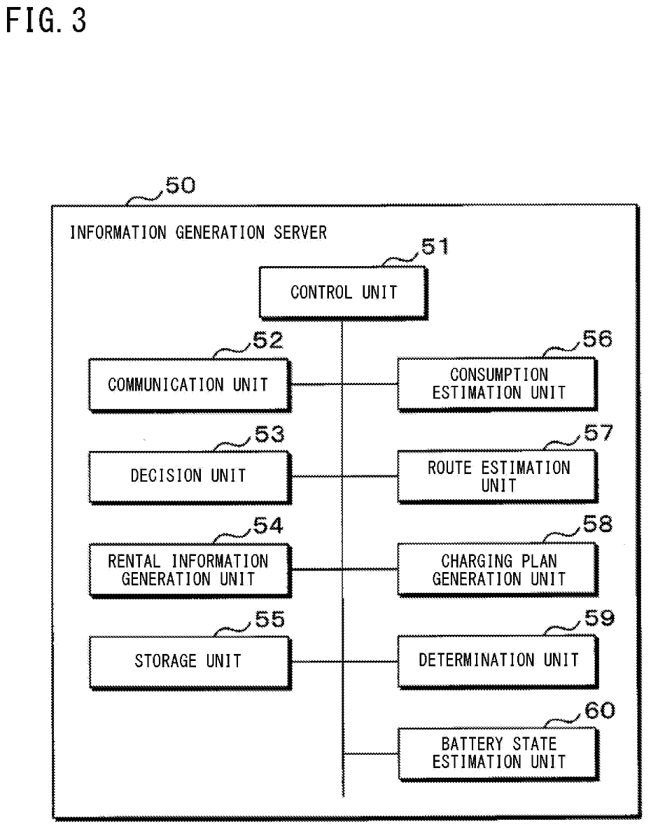

FIG. 3 is a block diagram showing an example of the configuration of the information generation server 50. The information generation server 50 includes a control unit 51 that controls the entire server, a communication unit 52, a decision unit 53, a rental information generation unit 54, a storage unit 55, a consumption estimation unit 56, a route estimation unit 57, a charging plan generation unit 58, a determination unit 59, and a battery state estimation unit 60.

The control unit 51 can be composed of a CPU, a ROM, a RAM, and the like. The CPU includes a processor. Each process performed by the server 50 can be performed by the processor.

The communication unit 52 provides a function of communication with the user terminal device 10, the battery information management server 20, the battery stock management server 30, and the vehicle stock management server 40 via the communication network 1.

The communication unit 52 has a function as a requirement information acquisition unit, and acquires a user's use requirement regarding use of a vehicle equipped with a battery, from the user terminal device 10. The use requirement includes a use content and an object to be rented. The use content includes a use period, a destination, a visiting place, a stay period, the number of users, a budget, etc. The object to be rented indicates whether to rent only a battery, only a vehicle, or both a vehicle and a battery. When the object to be rented includes a vehicle, the use requirement can include a vehicle model, a model year, a vehicle body color, etc. When the object to be rented includes a battery, the use requirement indicates whether cost is prioritized or traveling time is prioritized.

The communication unit 52 has a function as a stock information acquisition unit, and acquires stock information of objects including at least either one of a battery and a vehicle, from at least either one of the battery stock management server 30 and the vehicle stock management server 40. The stock information can include an identification number for identifying each object, reservation status/availability information and a use fee of each object, etc.

The decision unit 53 decides an object selection condition on the basis of the user's use requirement and the stock information acquired by the communication unit 52. The selection condition is a condition for narrowing down objects that meet the use requirement, from stored objects.

The rental information generation unit 54 has a function as a generation unit, and generates rental information regarding an object to be rented out to a user, on the basis of the selection condition decided by the decision unit 53. The rental information can include an identification number for identifying the object, a use period (rental period), a use fee, etc. The object identified by the rental information can be delivered to the user, and the user can use the object.

With the above configuration, the user can rent and use an object that meets a use requirement, merely by presenting the use requirement, so that an object (object to be rented out) corresponding to the user's request can be provided.

The storage unit 55 can store therein the user's use requirement and the stock information acquired by the communication unit 52. The storage unit 55 can store therein the selection condition decided by the decision unit 53 and the rental information generated by the rental information generation unit 54. In addition, the storage unit 55 can store therein a user information DB described later.

The consumption estimation unit 56, the route estimation unit 57, the charging plan generation unit 58, the determination unit 59, and the battery state estimation unit 60 will be described in detail later.

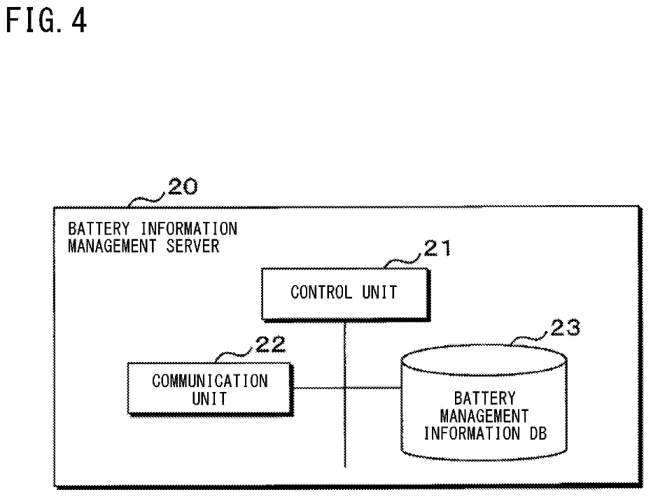

FIG. 4 is a block diagram showing an example of the configuration of the battery information management server 20. The battery information management server 20 includes a control unit 21 that controls the entire server, a communication unit 22, and a battery management information DB 23. The control unit 21 can be composed of a CPU, a ROM, a RAM, and the like. The CPU includes a processor. Each process performed by the battery information management server 20 can be performed by the processor.

The communication unit 22 provides a function of communication with the information generation server 50, the battery stock management server 30, and the vehicle stock management server 40 via the communication network 1.

The communication unit 22 can acquire specific information of a battery owned by a user. The control unit 21 can register and manage the specific information of the battery in the battery management information DB 23.

In addition, the control unit 21 can provide specific information of a battery managed, to the information generation server 50. The specific information of the battery will be described in detail later.

Next, the rental information generation system of the present embodiment will be described for the case where a user owns a vehicle and rents a battery, the case where a user owns a battery and rents a vehicle, and the case where a user rents both a vehicle and a battery. First, the case where a user owns a vehicle and rents a battery will be described.

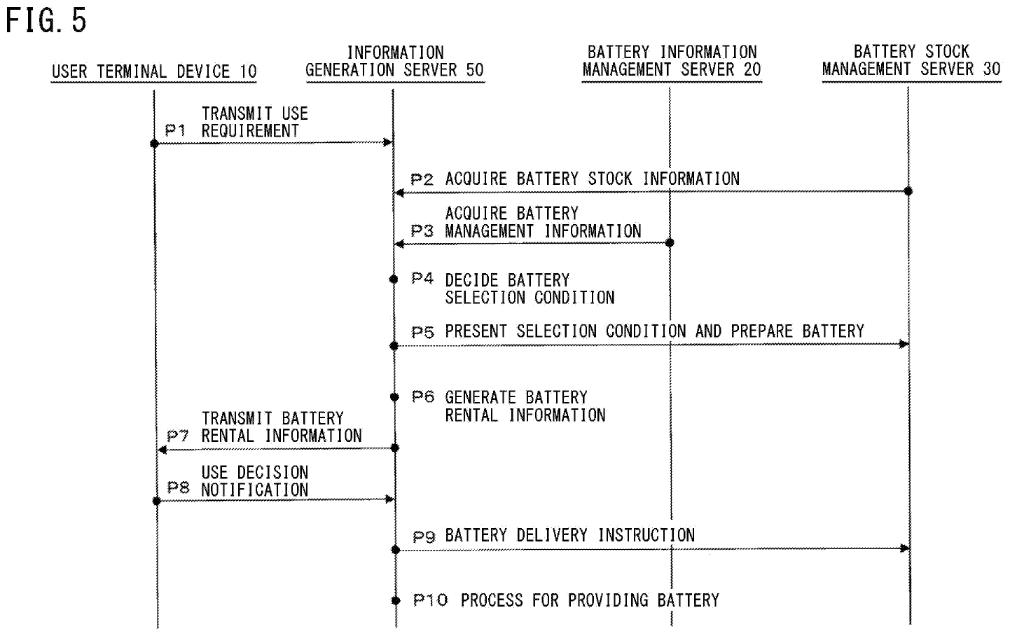

FIG. 5 is a schematic diagram showing an example of flow of information in the case where a user owns a vehicle and rents a battery. Hereinafter, processes P1 to P10 will be described.

In process P1, the user terminal device 10 transmits a use requirement to the information generation server 50.

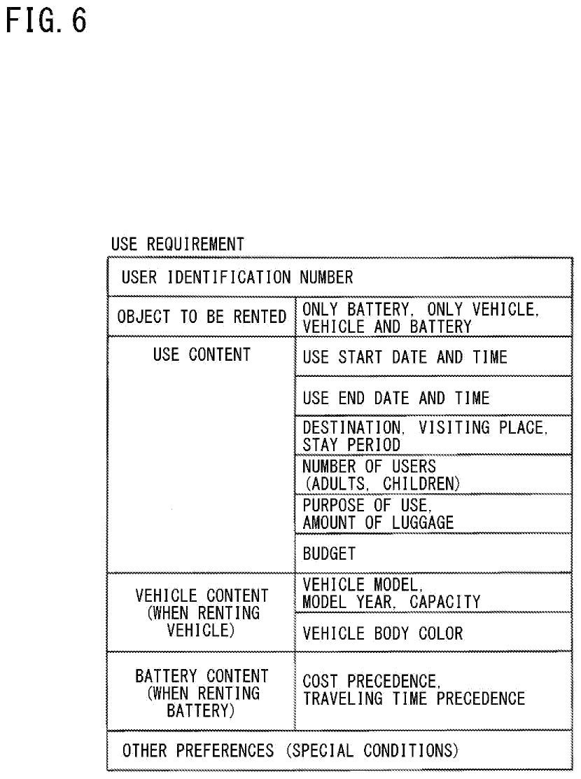

FIG. 6 is a schematic diagram showing an example of the use requirement. As shown in FIG. 6, the use requirement includes a user identification number for identifying the user, an object to be rented, a use content, a vehicle content (when renting a vehicle), a battery content (when renting a battery), other preferences (special conditions), etc.

The user identification number is information for association with user information. The user information will be described in detail later.

The object to be rented indicates whether to rent only a battery, only a vehicle, or both a vehicle and a battery.

The use content includes use start date and time, use end date and time, a destination, a visiting place, a stay period, the number of users (adults, children), the purpose of use, an amount of luggage, and all or part of a budget. The use content is not limited to the example shown in FIG. 6.

The vehicle content can include a vehicle model, a model year, a capacity, a vehicle body color, etc. The vehicle content is not limited to the example shown in FIG. 6.

The battery content can include cost precedence, traveling time precedence, etc. The battery content is not limited to the example shown in FIG. 6.

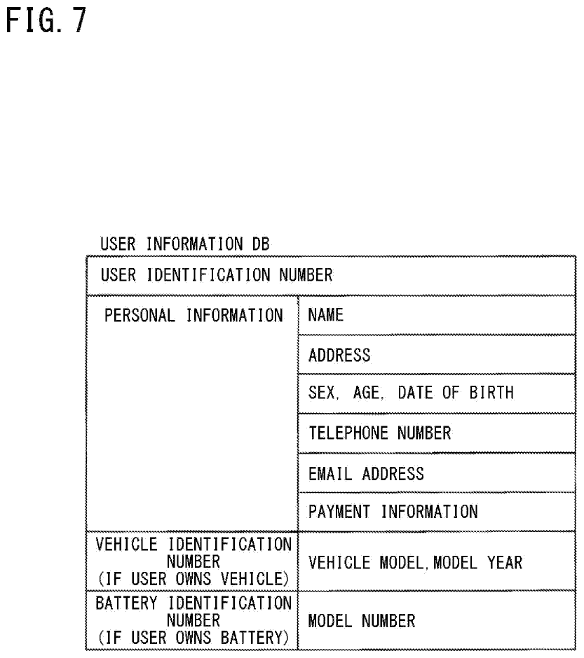

FIG. 7 is a schematic diagram showing an example of the structure of the user information DB. As shown in FIG. 7, the user information DB includes a user identification number, personal information, a vehicle identification number (if the user owns a vehicle), a battery identification number (if the user owns a battery), etc. The personal information can include the name, address, sex, age, date of birth, telephone number, email address, and payment information (for example, credit card information, etc.) of the user. The user information is not limited to the example of FIG. 7.

That is, the control unit 51 has a function as a possession information acquisition unit, and acquires vehicle information of a vehicle owned by a user. In this case, the user rents a battery to be mounted to the vehicle owned by the user. The vehicle information can include an identification number for identifying the vehicle (vehicle content).

In process P2, the information generation server 50 acquires battery stock information from the battery stock management server 30.

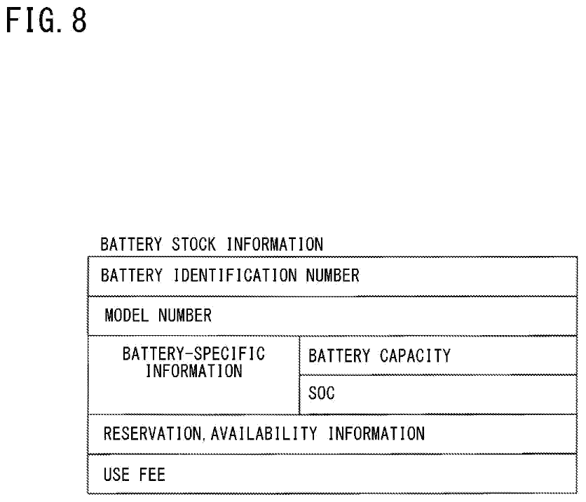

FIG. 8 is a schematic diagram showing an example of the structure of the battery stock information. As shown in FIG. 8, the battery stock information can include a battery identification number, a model number, battery-specific information (for example, battery capacity, SOC, etc.), reservation/availability information, a use fee, etc. The battery stock information is not limited to the example of FIG. 8.

That is, the communication unit 52 acquires battery stock information.

In process P3, the information generation server 50 acquires battery management information from the battery information management server 20.

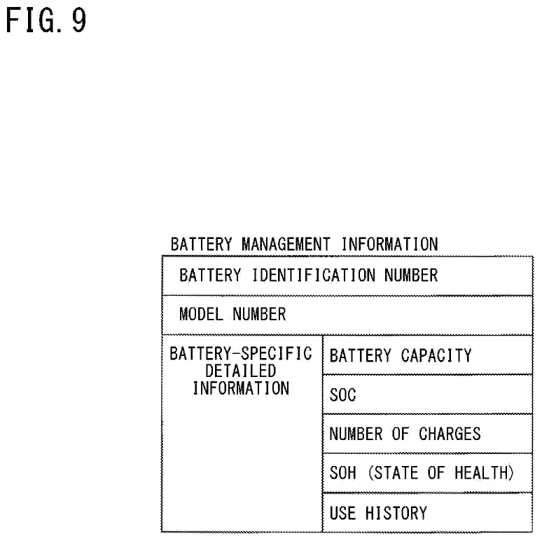

FIG. 9 is a schematic diagram showing an example of the structure of the battery management information. As shown in FIG. 9, the battery management information can include a battery identification number, a model number, battery-specific detailed information (for example, battery capacity, SOC, number of charges, SOH (State Of Health), use history, etc.), etc. The battery management information is not limited to the example of FIG. 9. The SOC (State Of Charge) is a quantity of state representing the ratio of the remaining charge of the secondary battery relative to a full charge capacity.

In process P4, the information generation server 50 decides a battery selection condition.

That is, the decision unit 53 decides a battery selection condition on the basis of the use requirement, and the acquired vehicle information and battery stock information. The selection condition is a condition for narrowing down batteries that meet the use requirement and match the vehicle owned by the user, from stored batteries.

In process P5, the information generation server 50 transmits (presents) the decided selection condition to the battery stock management server 30, and performs battery preparation. The battery preparation is to select and ensure a battery that satisfies the selection condition, from among a plurality of batteries stored.

In process P6, the information generation server 50 generates battery rental information.

That is, the rental information generation unit 54 generates rental information regarding the battery to be rented out to the user.

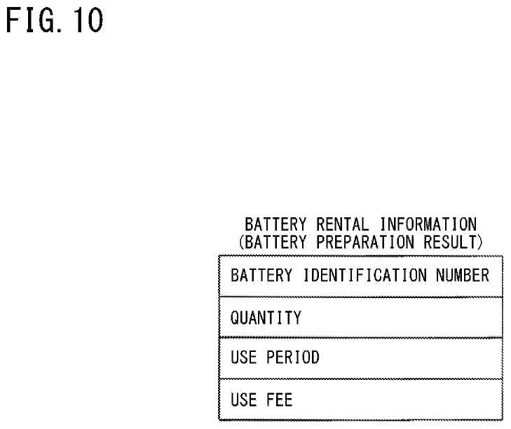

FIG. 10 is a schematic diagram showing an example of the battery rental information. As shown in FIG. 10, the battery rental information can include a battery identification number for identifying the battery, a quantity, a use period (rental period), a use fee, etc. As will be described later, the battery identified by the rental information can be delivered to the user, and the user can mount the battery to the vehicle and use the vehicle.

In process P7, the information generation server 50 transmits the generated battery rental information to the user terminal device 10.

In process P8, when the user determines that the presented battery rental information matches the user's request, and performs an operation for use decision on the user terminal device 10, the user terminal device 10 transmits a use decision notification to the information generation server 50.

In process P9, when the information generation server 50 acquires the use decision notification, the information generation server 50 transmits a battery delivery instruction to the battery stock management server 30. Accordingly, the battery sharing service provider can deliver the battery identified by the rental information, to the user.

In process P10, the information generation server 50 performs a process for providing the battery. The process for providing the battery includes, for example, a charging process for charging the use fee on the user, a payment process, or the like.

With the above configuration, the user can rent and use a battery that meets a use requirement, merely by presenting the use requirement, so that a battery that matches the vehicle owned by the user and the user's own request can be easily selected.

Next, specific processes of the information generation server 50 will be described.

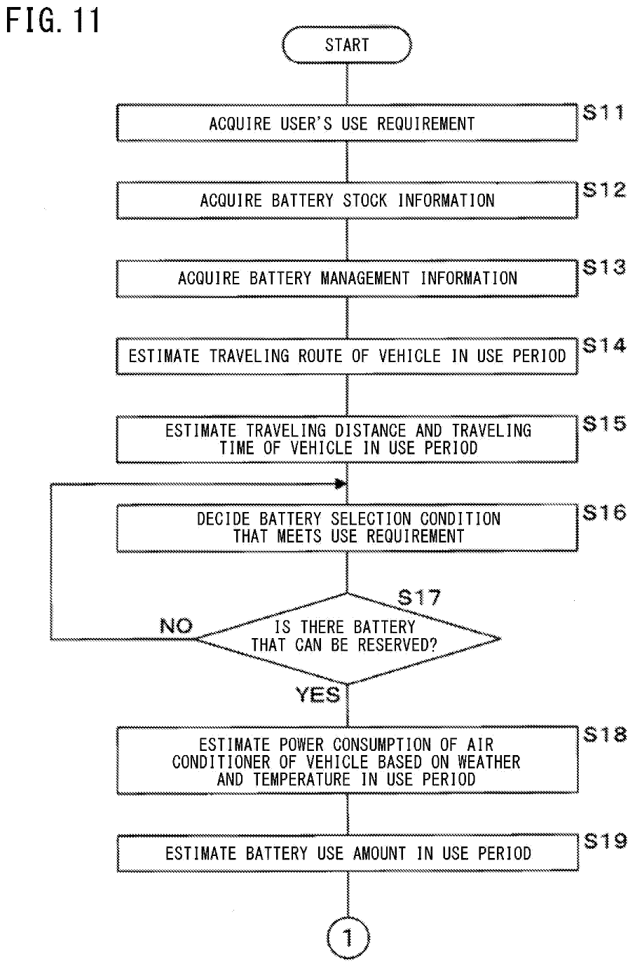

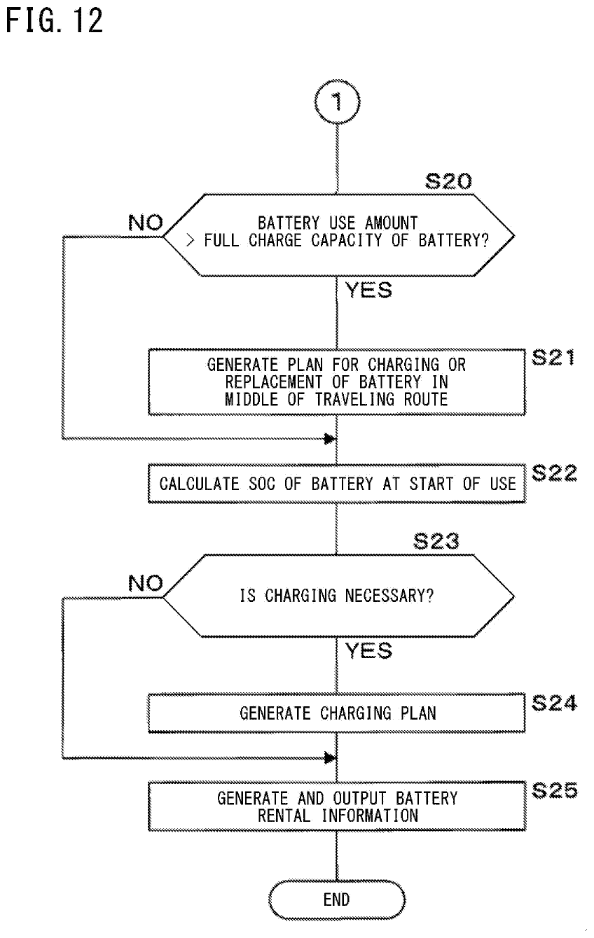

FIG. 11 and FIG. 12 are flowcharts showing an example of a process procedure of the information generation server 50 in the case where a user owns a vehicle and rents a battery. For convenience, the following is described assuming that the subject that performs the processes is the control unit 51. The control unit 51 acquires a user's use requirement (S11), acquires battery stock information (S12), and acquires battery management information (S13).

The control unit 51 estimates a traveling route of a vehicle in a use period (S14).

More specifically, the control unit 51 acquires a use requirement including a use date of the vehicle and a destination. The use date includes, for example, a use start date and a use end date (that is, a use period). The destination is not limited to one, and can include a plurality of destinations to be visited during the use days.

The route estimation unit 57 estimates a traveling route on the basis of the acquired use period and destination. As for the traveling route, traffic jams in the use period may be predicted, and a traveling route that avoids the traffic jams may be estimated, or a traveling route with a short traveling distance may be estimated, or a traveling route with a short traveling time (through which the destination can be reached earliest) may be estimated, or a traveling route with a better electric mileage may be estimated. The traveling route can be estimated according to the user's use requirement.

The control unit 51 estimates a traveling distance and a traveling time of the vehicle in the use period on the basis of the estimated traveling route (S15). The control unit 51 decides a battery selection condition that meets the use requirement (S16).

Specifically, the decision unit 53 decides a battery selection condition on the basis of at least one of the estimated traveling route, traveling distance, and traveling time. For example, when renting out a battery, the full charge capacity of a battery can be selected on the basis of the traveling route.

Accordingly, more specific traveling route information can be extracted from the use requirement presented by the user, the implicit request of the user based on the viewpoint of traveling route can be grasped, and a battery that further matches the user's request can be provided.

The control unit 51 determines whether there is a battery that can be reserved (S17). When there is no battery that can be reserved (NO in S17), the control unit 51 repeats the process in step S16. When there is a battery that can be reserved (YES in S17), the control unit 51 estimates the power consumption of the air conditioner of the vehicle based on the weather and the temperature in the use period (S18), and estimates the battery use amount in the use period (S19).

Specifically, the consumption estimation unit 56 has a function as a consumption estimation unit, and estimates the power consumption of the battery on the basis of the acquired use requirement and the estimated traveling route. For example, the consumption estimation unit 56 estimates the amount of power consumed by the battery (battery use amount) when the vehicle is used in the period from the use start date to the use end date.

The control unit 51 determines whether the battery use amount is larger than the full charge capacity of the battery (S20). When the battery use amount is larger than the full charge capacity of the battery (YES in S20), the control unit 51 generates a plan for charging or replacement of the battery in the middle of the traveling route (S21), and performs a process in step S22 described later.

Specifically, the determination unit 59 has a function as a necessity determination unit, and determines whether charging or replacement of the battery in the middle of the traveling route is necessary, on the basis of the estimated power consumption. Such necessity determination can be performed, for example, on the basis of whether the estimated power consumption is larger than the full charge capacity of the battery. Accordingly, a plan for battery replacement or charging to be required during use of the vehicle is generated in advance, and thus a situation in which the vehicle becomes unable to travel while the user is using the vehicle can be prevented.

When the battery use amount is not larger than the full charge capacity of the battery (NO in S20), the control unit 51 calculates the SOC of the battery at the start of use (S22).

Specifically, the battery state estimation unit 60 can estimate (calculate) the SOC of the battery on the basis of acquired specific information of the battery and the time from the present time to the use start time. The specific information includes, for example, the SOC at the present time. The specific information may be acquired from the battery stock information, or may be acquired from a device such as the battery information management server 20.

The control unit 51 determines whether charging of the battery is necessary (S23). For example, the control unit 51 obtains in advance the SOC of the battery at the time when the use of the vehicle is started, and can determine whether it is necessary to charge the battery before the start of use, in accordance with whether the SOC of the battery becomes less than a lower limit before the end of use.

When charging is necessary (YES in S23), the control unit 51 generates a charging plan (S24) and performs a process in step S25 described later. Specifically, the charging plan generation unit 58 generates a battery charging plan on the basis of the estimated power consumption and the acquired specific information. Accordingly, it is not necessary to charge the battery during use of the vehicle, so that the convenience of the user can be improved. That is, the battery information management server 20 (control unit 21) can provide the specific information of the battery, which is used for generating a battery charging plan, to the information generation server 50.

When charging is not necessary (NO in S23), the control unit 51 generates and outputs battery rental information (S25) and ends the process.

Next, the case where a user owns a battery and rents a vehicle will be described.

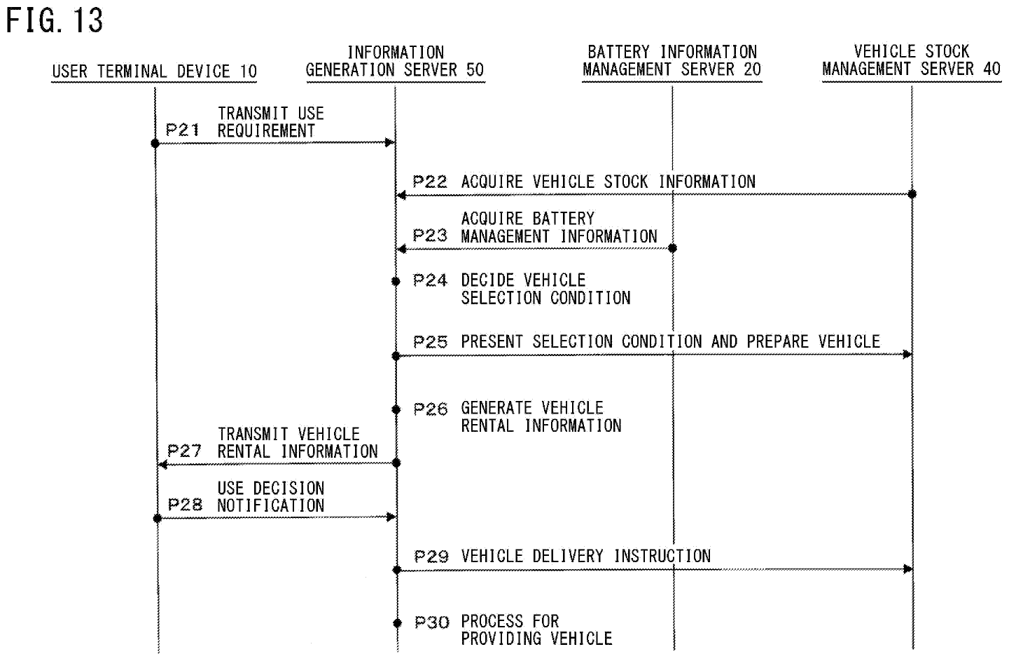

FIG. 13 is a schematic diagram showing an example of flow of information in the case where a user owns a battery and rents a vehicle. Hereinafter, processes P21 to P30 will be described.

In process P21, the user terminal device 10 transmits a use requirement to the information generation server 50.

That is, the control unit 51 acquires battery information of the battery owned by the user, on the basis of the use requirement. In this case, the user rents a vehicle on which all or part of the battery owned by the user is mounted. The battery information can include an identification number for identifying the battery.

In process P22, the information generation server 50 acquires vehicle stock information from the vehicle stock management server 40.

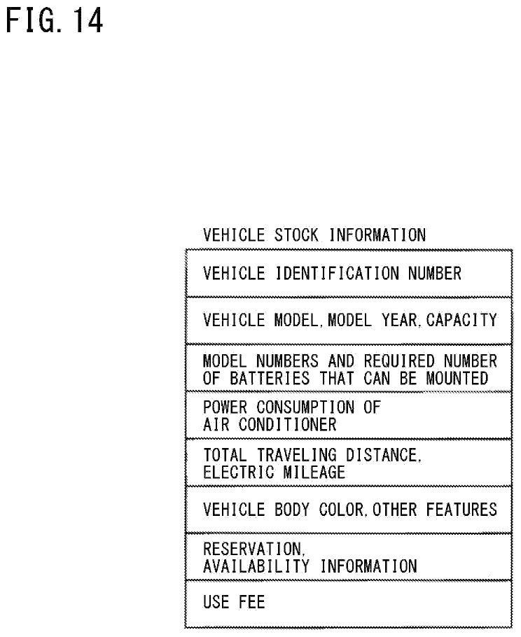

FIG. 14 is a schematic diagram showing an example of the structure of the vehicle stock information. As shown in FIG. 14, the vehicle stock information can include a vehicle identification number, a vehicle model, a model year, a capacity, the model numbers and the required number of batteries that can be mounted, a power consumption of an air conditioner, a total traveling distance, an electric mileage, a vehicle body color, other features, reservation/availability information, a use fee, etc. The vehicle stock information is not limited to the example of FIG. 14.

That is, the communication unit 52 acquires vehicle stock information.

In process P23, the information generation server 50 acquires battery management information from the battery information management server 20.

In process P24, the information generation server 50 decides a vehicle selection condition.

That is, the decision unit 53 decides a vehicle selection condition on the basis of the use requirement, and the acquired battery management information and vehicle stock information. The selection condition is a condition for narrowing down vehicles that meet the use requirement and match the battery owned by the user, from stored vehicles.

In process P25, the information generation server 50 transmits (presents) the decided selection condition to the vehicle stock management server 40, and performs vehicle preparation. The vehicle preparation is to select and ensure a vehicle that satisfies the selection condition, from among a plurality of vehicles stored.

In process P26, the information generation server 50 generates vehicle rental information.

That is, the rental information generation unit 54 generates rental information regarding the vehicle to be rented out to the user.

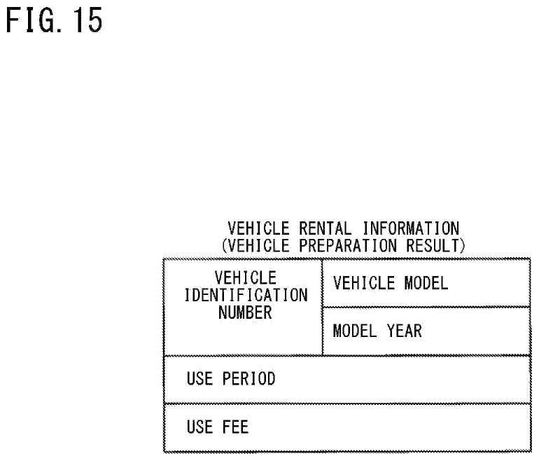

FIG. 15 is a schematic diagram showing an example of the vehicle rental information. As shown in FIG. 15, the vehicle rental information can include a vehicle identification number for identifying the vehicle (including, for example, a vehicle model, a model year, etc.), a use period (rental period), a use fee, etc. As will be described later, the vehicle identified by the rental information can be delivered to the user, and the user can mount the battery to the vehicle and use the vehicle.

In process P27, the information generation server 50 transmits the generated vehicle rental information to the user terminal device 10.

In process P28, when the user determines that the presented vehicle rental information matches the user's request, and performs an operation for use decision on the user terminal device 10, the user terminal device 10 transmits a use decision notification to the information generation server 50.

In process P29, when the information generation server 50 acquires the use decision notification, the information generation server 50 transmits a vehicle delivery instruction to the vehicle stock management server 40. Accordingly, the vehicle sharing service provider can deliver the vehicle identified by the rental information, to the user.

In process P30, the information generation server 50 performs a process for providing the vehicle. The process for providing the vehicle includes, for example, a charging process for charging the use fee on the user, a payment process, or the like.

With the above configuration, the user can rent and use a vehicle that meets a use requirement, merely by presenting the use requirement, so that a vehicle that matches the battery owned by the user and the user's own request can be easily selected.

Next, specific processes of the information generation server 50 will be described.

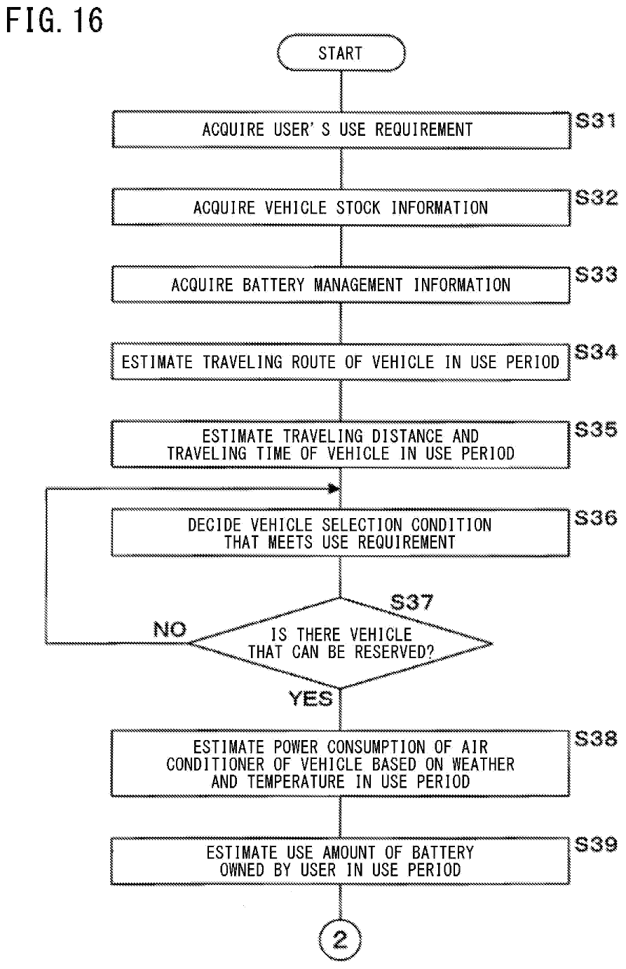

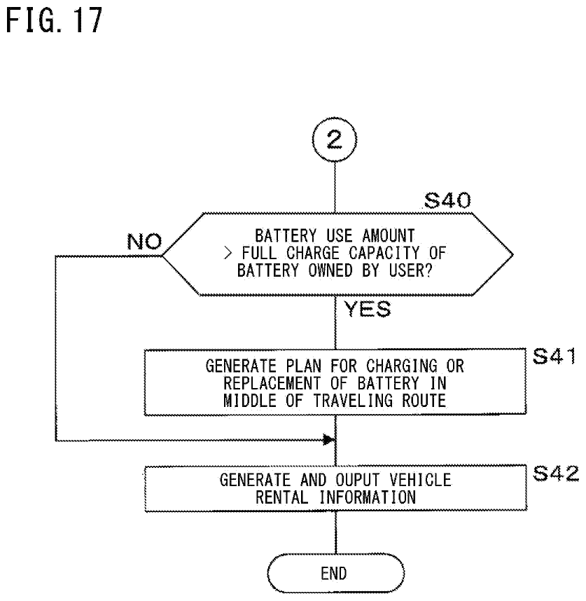

FIG. 16 and FIG. 17 are flowcharts showing an example of a process procedure of the information generation server 50 in the case where a user owns a battery and rents a vehicle. The control unit 51 acquires a user's use requirement (S31), acquires vehicle stock information (S32), and acquires battery management information (S33).

The control unit 51 estimates a traveling route of the vehicle in a use period (S34). The estimation of the traveling route is the same as the process in step S14 in FIG. 11. The control unit 51 estimates a traveling distance and a traveling time of the vehicle in the use period on the basis of the estimated traveling route (S35). The control unit 51 decides a vehicle selection condition that meets the use requirement (S36).

Specifically, the decision unit 53 decides a vehicle selection condition on the basis of at least one of the estimated traveling route, traveling distance, and traveling time. For example, when renting out a vehicle, the size or vehicle model of a vehicle can be selected on the basis of the traveling route. That is, when the traveling route is longer, a vehicle that is more comfortable for the user can be selected.

Accordingly, further specific traveling route information can be extracted from the use requirement presented by the user, the implicit request of the user based on the viewpoint of traveling route can be grasped, and a vehicle that further matches the user's request can be provided.

The control unit 51 determines whether there is a vehicle that can be reserved (S37). When there is no vehicle that can be reserved (NO in S37), the control unit 51 repeats the process in step S36. When there is a vehicle that can be reserved (YES in S37), the control unit 51 estimates the power consumption of the air conditioner of the vehicle based on the 196217 weather and the temperature in the use period (S38), and estimates the battery use amount of the battery owned by the user in the use period (S39). The estimation of the battery use amount is the same as the process in step S19 in FIG. 11.

The control unit 51 determines whether the battery use amount is larger than the full charge capacity of the battery owned by the user (S40). When the battery use amount is larger than the full charge capacity of the battery (YES in S40), the control unit 51 generates a plan for charging or replacement of the battery in the middle of the traveling route (S41), and performs a process in step S42 described later. The processes in steps S40 and S41 are the same as the processes in steps S20 and S21 in FIG. 12. When the battery use amount is not larger than the full charge capacity of the battery (NO in S40), the control unit 51 generates and outputs vehicle rental information (S42) and ends the process.

Next, the case where a user rents both a vehicle and a battery will be described.

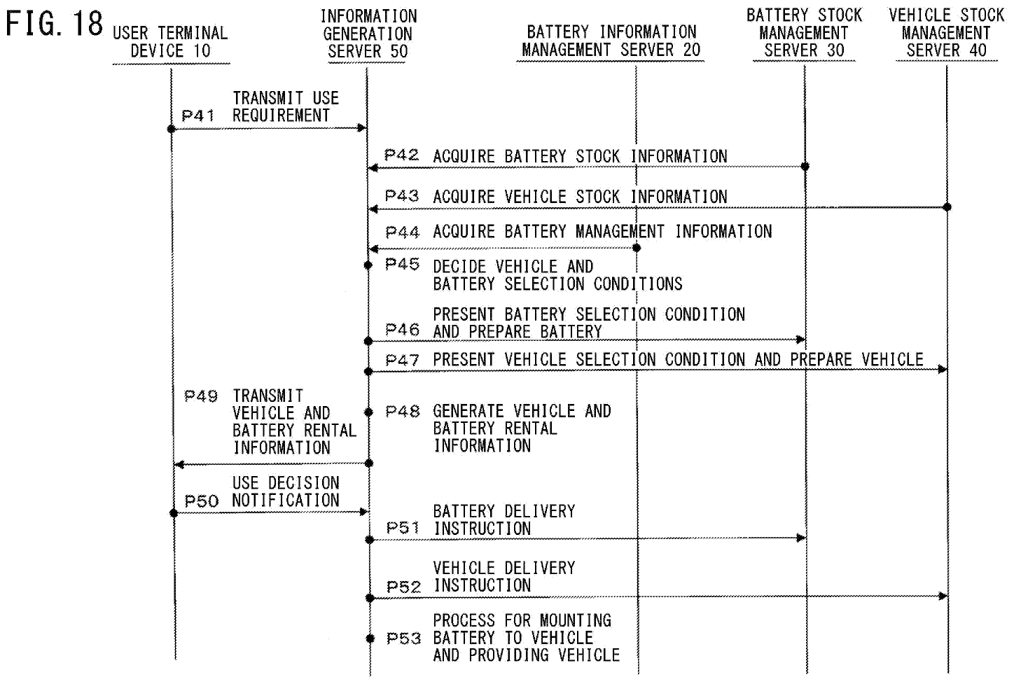

FIG. 18 is a schematic diagram showing an example of flow of information in the case where a user rents both a vehicle and a battery. Hereinafter, processes P41 to P53 will be described.

In process P41, the user terminal device 10 transmits a use requirement to the information generation server 50.

In process P42, the information generation server 50 acquires battery stock information from the battery stock management server 30.

In process P43, the information generation server 50 acquires vehicle stock information from the vehicle stock management server 40.

In process P44, the information generation server 50 acquires battery management information from the battery information management server 20.

In process P45, the information generation server 50 decides vehicle and battery selection conditions.

That is, the decision unit 53 decides battery and vehicle selection conditions on the basis of the use requirement, and the acquired battery and vehicle stock information. The selection conditions are conditions for narrowing down vehicles and batteries that meet the use requirement, from stored vehicles and batteries.

In process P46, the information generation server 50 transmits (presents) the battery selection condition to the battery stock management server 30, and performs battery preparation.

In process P47, the information generation server 50 transmits (presents) the vehicle selection condition to the vehicle stock management server 40, and performs vehicle preparation.

Although not shown, the decision unit 53 can also decide a selection condition for a combination of a battery and a vehicle on the basis of the use requirement and the acquired battery and vehicle stock information. When a battery selection condition and a vehicle selection condition are decided independently, for example, whereas a condition that a heavy vehicle is selected may be decided, a condition that a battery that tends to consume power is selected may be decided. In such a case, the distance for which the vehicle can travel becomes shorter, which is not preferable. Therefore, for example, a selection condition is decided for a combination of a battery and a vehicle such that a battery having a capacity corresponding to the weight of a vehicle can be selected. Accordingly, a combination of a battery and a vehicle that meet the use requirement can be determined from the stored vehicles and batteries.

In process P48, the information generation server 50 generates vehicle and battery rental information.

That is, the rental information generation unit 54 generates rental information regarding the battery and the vehicle to be rented out to the user. The vehicle and the battery identified by the rental information are delivered to a predetermined place, and work for mounting the battery to the vehicle is performed. The vehicle having the battery mounted thereon is delivered to the user, and the user can use the vehicle immediately.

In process P49, the information generation server 50 transmits the generated vehicle and battery rental information to the user terminal device 10.

In process P50, when the user determines that the presented vehicle and battery rental information match the user's request, and performs an operation for use decision on the user terminal device 10, the user terminal device 10 transmits a use decision notification to the information generation server 50.

In process P51, when the information generation server 50 acquires the use decision notification, the information generation server 50 transmits a battery delivery instruction to the battery stock management server 30. Accordingly, the battery sharing service provider can deliver the battery identified by the rental information, for example, to a work place of the sharing service coordinator.

In process P52, the information generation server 50 transmits a vehicle delivery instruction to the vehicle stock management server 40. Accordingly, the vehicle sharing service provider can deliver the vehicle identified by the rental information, to the work place of the sharing service coordinator.

In process P53, the information generation server 50 performs a process for mounting the battery to the vehicle and a process for providing the vehicle. The process for mounting the battery to the vehicle is a process required for identifying the combination of the delivered vehicle and battery and mounting the battery to the vehicle. The process for providing the vehicle includes, for example, a charging process for charging the use fee on the user, a payment process, or the like.

With the above configuration, the user can rent and use a vehicle on which a battery that meets a use requirement is mounted, merely by presenting the use requirement, so that a combination of a vehicle and a battery that match the user's own request can be easily selected.

Next, specific processes of the information generation server 50 will be described.

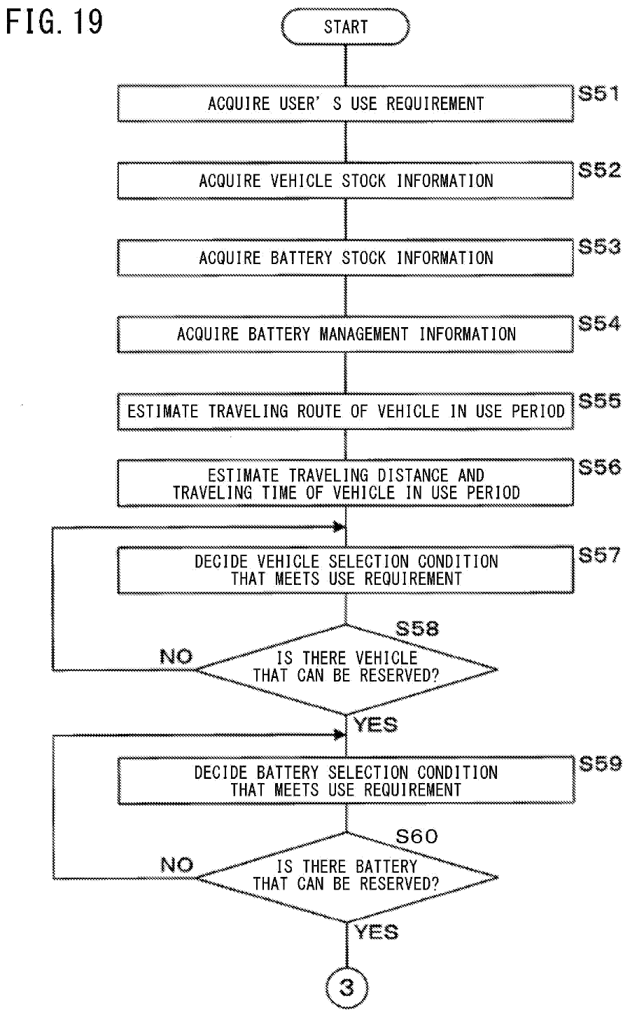

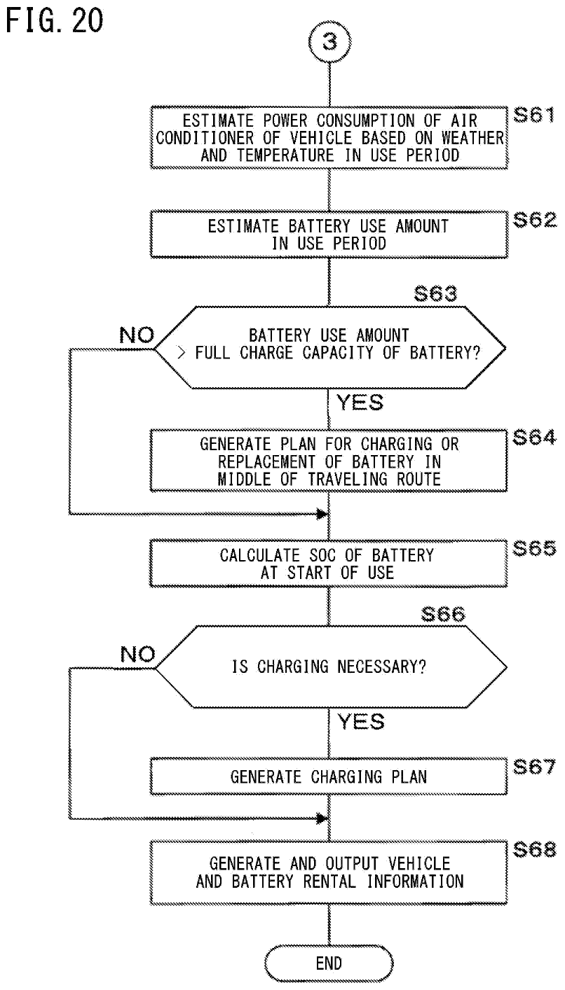

FIG. 19 and FIG. 20 are flowcharts showing an example of a process procedure of the information generation server 50 in the case where a user rents both a vehicle and a battery. The control unit 51 acquires a user's use requirement (S51) and acquires vehicle stock information (S52). The control unit 51 acquires battery stock information (S53) and acquires battery management information (S54).

The control unit 51 estimates a traveling route of the vehicle in a use period (S55), estimates a traveling distance and a traveling time of the vehicle in the use period on the basis of the estimated traveling route (S56), and decides a vehicle selection condition that meets the use requirement (S57).

The control unit 51 determines whether there is a vehicle that can be reserved (S58). When there is no vehicle that can be reserved (NO in S58), the control unit 51 repeats the process in step S57. When there is a vehicle that can be reserved (YES in S58), the control unit 51 decides a battery selection condition that meets the use requirement (S59). The control unit 51 determines whether there is a battery that can be reserved (S60). When there is no battery that can be reserved (NO in S60), the control unit 51 repeats the process in step S59.

When there is a battery that can be reserved (YES in S60), the control unit 51 estimates the power consumption of the air conditioner of the vehicle based on the weather and the temperature in the use period (S61), and estimates the battery use amount in the use period (S62). The control unit 51 determines whether the battery use amount is larger than the full charge capacity of the battery (S63). When the battery use amount is larger than the full charge capacity of the battery (YES in S63), the control unit 51 generates a plan for charging or replacement of the battery in the middle of the traveling route (S64), and performs a process in step S65 described later.

When the battery use amount is not larger than the full charge capacity of the battery (NO in S63), the control unit 51 calculates the SOC of the battery at the start of use (S65). The control unit 51 determines whether charging of the battery is necessary (S66). When charging is necessary (YES in S66), the control unit 51 generates a charging plan (S67) and performs a process in step S68 described later.

When charging is not necessary (NO in S66), the control unit 51 generates and outputs vehicle and battery rental information (S68) and ends the process.

In the above first embodiment, when the voltage difference between a plurality of batteries is larger than a predetermined threshold, the charging plan generation unit 58 may generate a charging plan that equalizes the voltages of the plurality of batteries.

For example, when batteries having different capacities, battery characteristics, or the like, are mounted together on one vehicle, the voltage difference between the multiple batteries may become larger than the predetermined threshold. If the batteries are mounted together (for example, connected in parallel) in such a state, an excessive current flows between the multiple batteries, resulting in deterioration of the batteries. The voltages may be equalized, for example, by charging a battery having a lower voltage to increase the voltage.

As described above, for example, a battery having a lower voltage is charged such that the voltage difference between the multiple batteries becomes equal to or less than the predetermined threshold. Accordingly, different batteries can be mounted together to the vehicle, and deterioration of the batteries can be suppressed.

### (Second Embodiment)

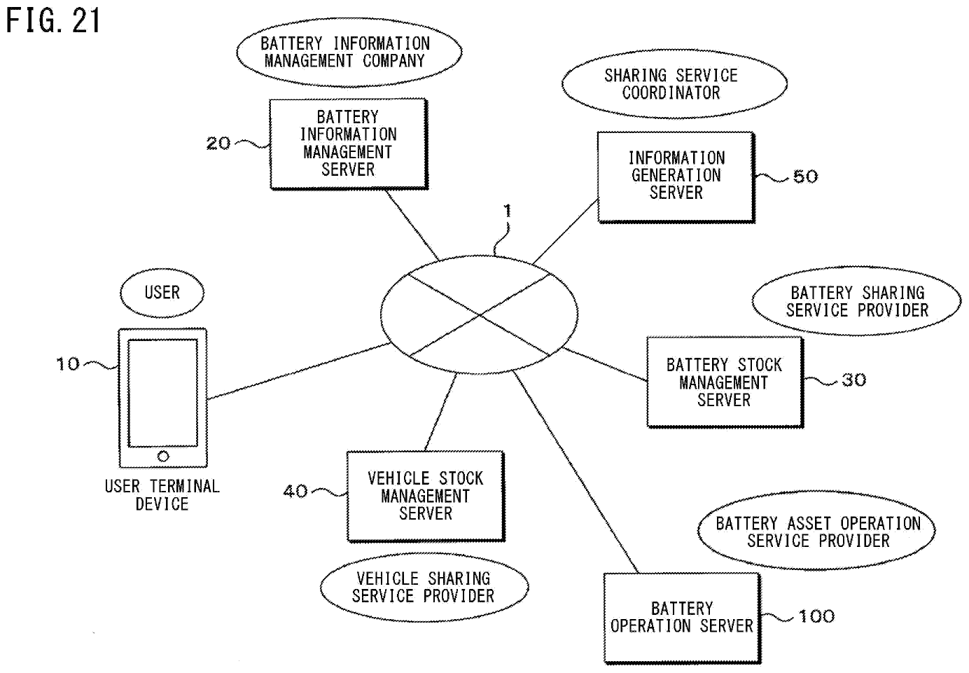

FIG. 21 is a schematic diagram showing an example of the configuration of a rental information generation system of a second embodiment. The difference from the first embodiment illustrated in FIG. 1 is that a battery operation server 100 operated by a battery asset operation service provider is included. As shown in FIG. 21, the battery operation server 100 is connected to the communication network 1, and can transmit and receive information to and from the user terminal device 10, the battery information management server 20, the battery stock management server 30, the vehicle stock management server 40, and the information generation server 50 via the communication network 1. In the example of FIG. 21, only one user terminal device 10 is shown, but a plurality of user terminal devices 10 of respective users can be connected.

A user can present an operation condition (also referred to as a provision condition) regarding battery operation to the battery asset operation service provider, and request the operation, maintenance, etc., of a battery owned by the user. The battery asset operation service provider performs storage and maintenance of the battery (for example, storage temperature control to suppress deterioration of the battery, SOC management during storage, and maintenance such as refresh charging/discharging) on behalf of the user. In addition, the battery asset operation service provider operates the battery on the basis of the operation condition presented by the user. The owner of the battery pays the expenses required for the operation, maintenance, etc., of the battery, to the battery asset operation service provider.

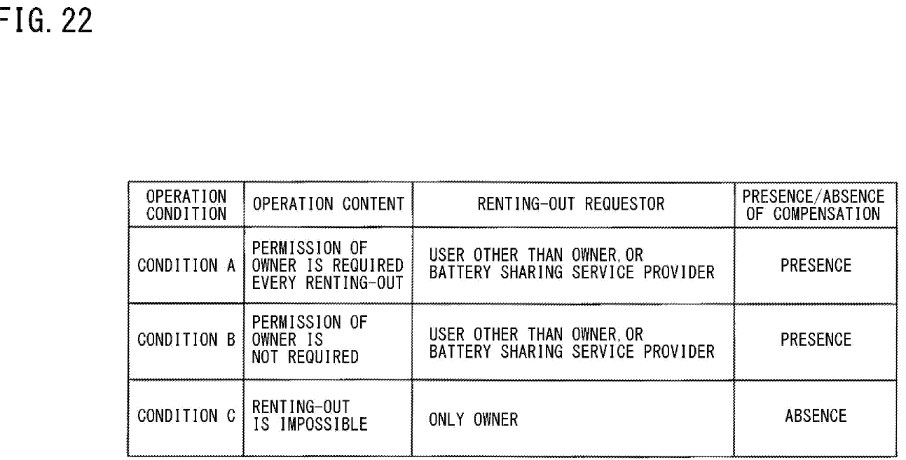

FIG. 22 is an explanatory diagram showing an example of battery operation by the battery asset operation service provider. In FIG. 22, three conditions, conditions A, B, and C, are exemplified as an operation condition. In the condition A, an owner permission system is employed, and when a battery owned by a user is rented out to another user, a permission of the owner is required each time the battery is rented out. The battery-renting-out requestor can be another user other than the owner, or the battery sharing service provider. In the condition A, when a battery is rented out, the battery asset operation service provider receives a compensation from the renter, and gives a part of the received compensation to the owner.

In the condition B, provision is always permitted (operation is entrusted), and when a battery owned by a user is rented out to another user, a permission of the owner is not required. The battery-renting-out requestor can be another user other than the owner, or the battery sharing service provider. In the condition B, when a battery is rented out, the battery asset operation service provider receives a compensation from the renter, and gives a part of the received compensation to the owner.

In the condition C, provision is not permitted, that is, only an owner can use a battery, and the battery cannot be rented out. The renting-out requestor is only the owner, and there is no compensation for renting out the battery.

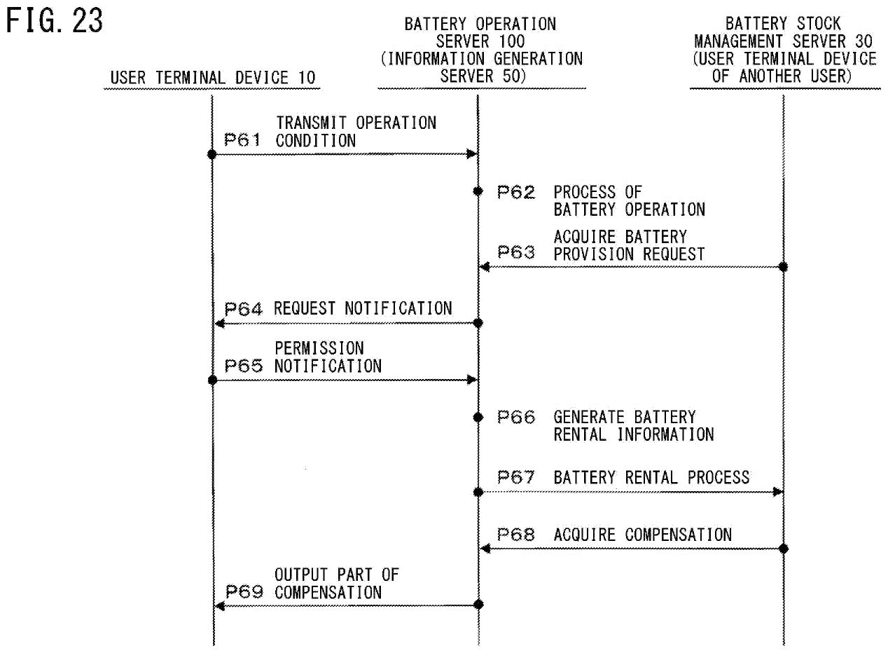

FIG. 23 is a schematic diagram showing an example of flow of information in the case where the battery asset operation service provider operates a battery owned by a user. Hereinafter, processes P61 to P69 will be described.

In process P61, the user terminal device 10 of the user (owner) who owns the battery transmits an operation condition of the battery to the battery operation server 100. The battery asset operation service provider and the sharing service coordinator may be the same business operator, and in this case, the battery operation server 100 can be replaced with the information generation server 50.

In process P62, the battery operation server 100 performs a process of battery operation. The process of battery operation can include, for example, a process required for battery maintenance.

In process P63, the battery operation server 100 acquires a battery provision request from the battery stock management server 30 or the user terminal device 10 of another user different from the owner. In the following description, the operation condition is assumed to be the condition A (owner permission system).

In process P64, the battery operation server 100 transmits a request notification to the user terminal device 10 of the owner.

In process P65, a permission of the owner is obtained, and the user terminal device 10 transmits a permission notification to the battery operation server 100.

In process P66, the battery operation server 100 generates battery rental information.

In process P67, the battery operation server 100 performs a battery rental process. The battery rental process can be, for example, a process required for the battery asset operation service provider to deliver the battery.

In process P68, the battery operation server 100 acquires a compensation (compensation information) from the battery stock management server 30 or the user terminal device 10 of the other user different from the owner.

In process P69, the battery operation server 100 outputs a part of the compensation (compensation information that identifies a part of the compensation) to the user terminal device 10 of the owner.

As described above, the control unit 51 has a function as a condition acquisition unit, and acquires a condition regarding battery operation from the user (owner) who owns the battery. The user who owns the battery can entrust the battery owned by the user, to the battery asset operation service provider, and request the operation (maintenance, renting-out to another user, etc.) of the battery.

The rental information generation unit 54 generates rental information regarding the battery to be operated on the basis of the condition. Accordingly, the battery can be provided to another user different from the owner, in accordance with the condition presented by the owner of the battery.

In addition, the condition includes a first condition that requires a permission of the owner each time the battery is rented out, a second condition that does not require a permission of the owner, and a third condition that does not permit the battery to be rented out. Accordingly, the number of options when the operation of the owned battery is entrusted is increased, making it easier for the user who owns the battery to entrust the operation of the battery to the business operator.

In the second embodiment, the battery asset operation service provider and the battery sharing service provider may be the same business operator.

Next, the operations on the user terminal device 10 will be described.

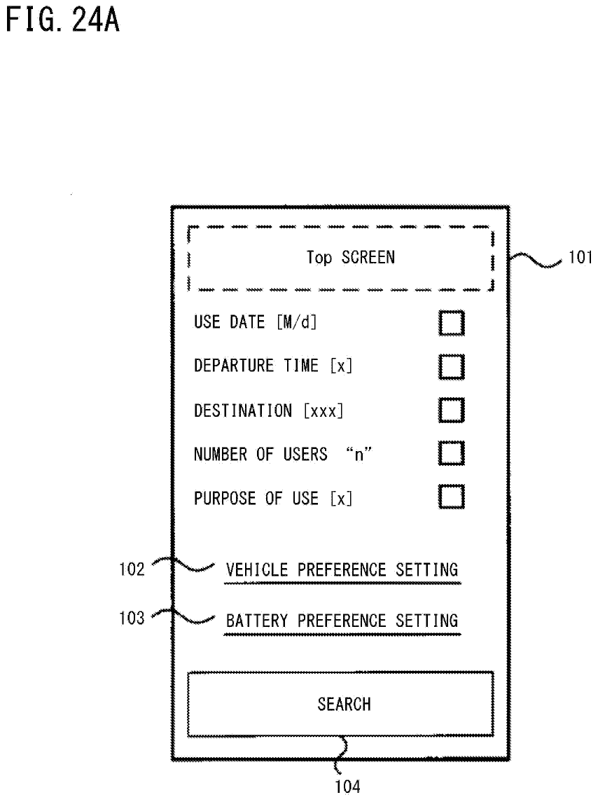

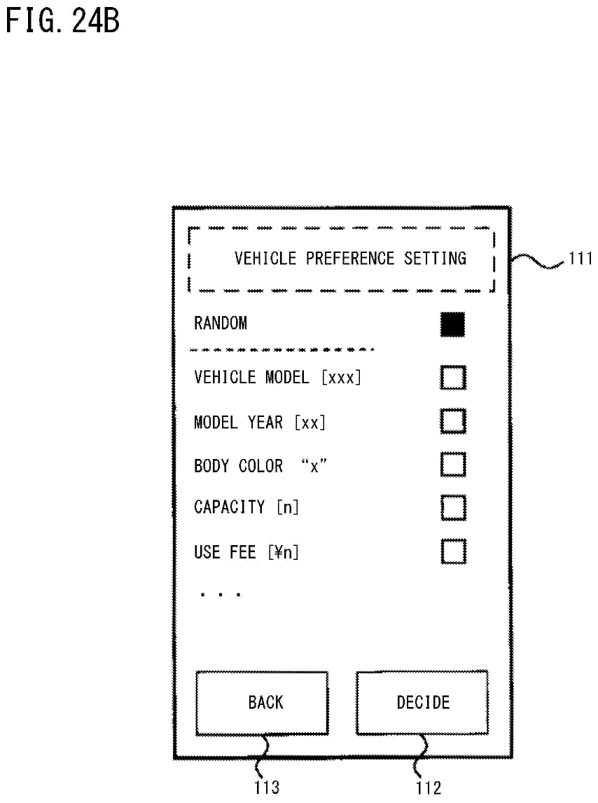

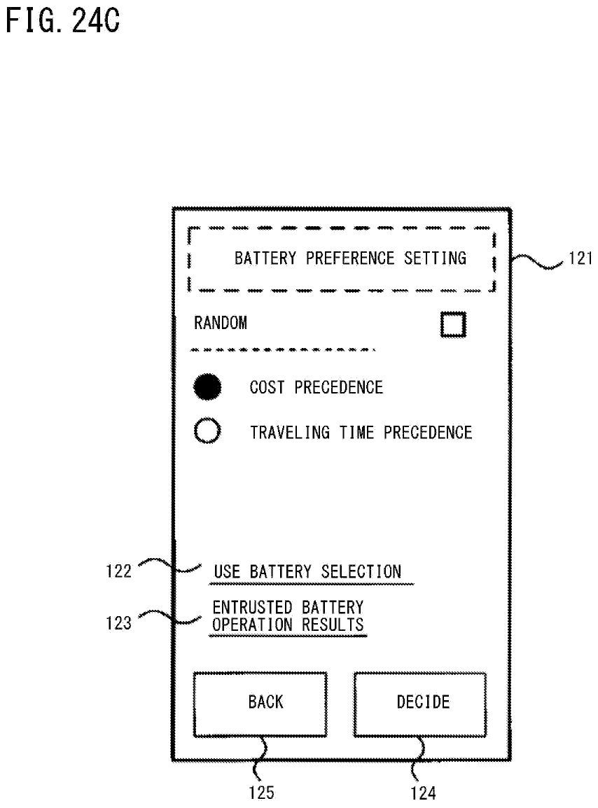

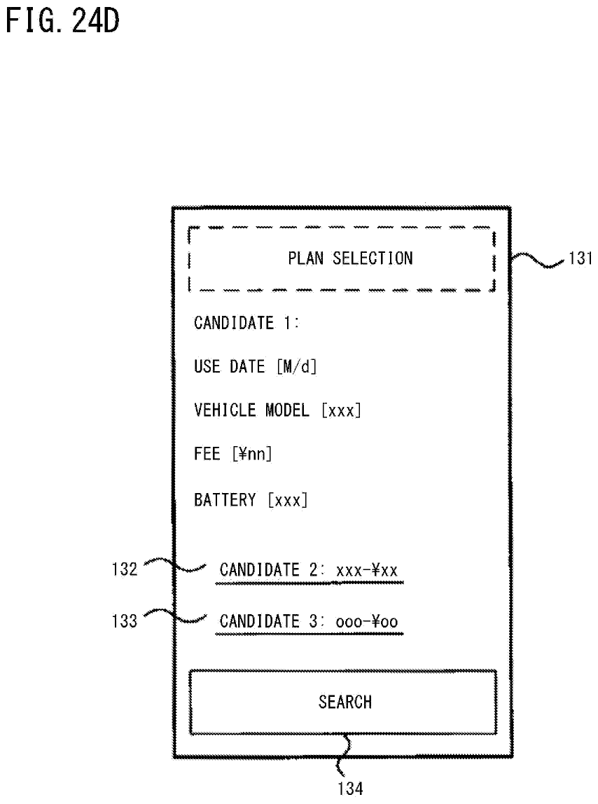

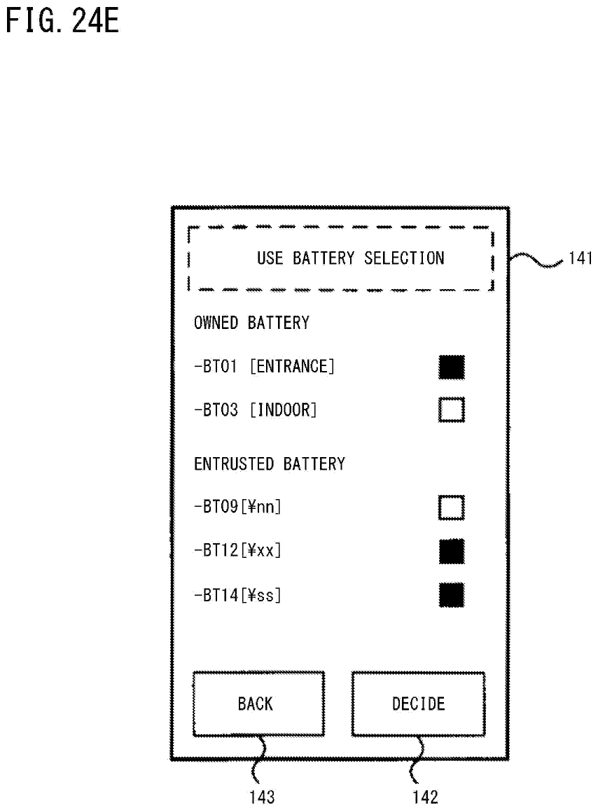

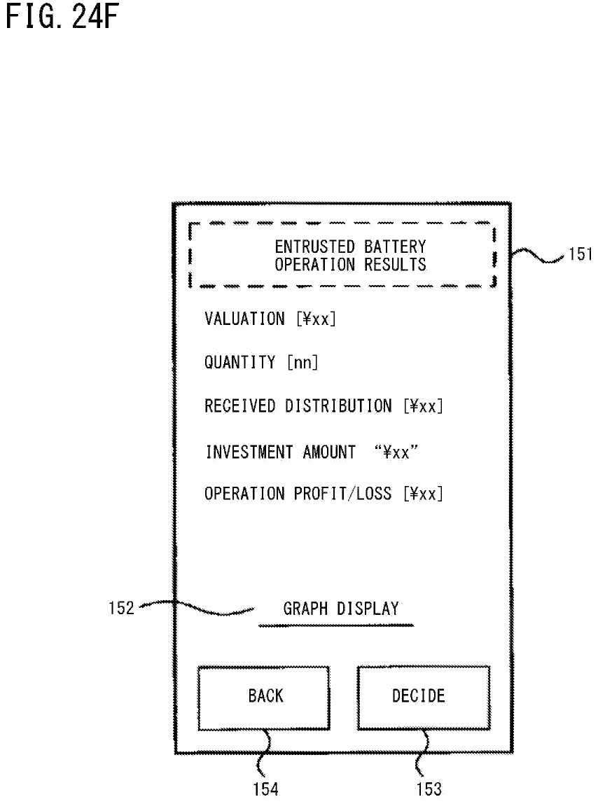

FIG. 24A to FIG. 24F are schematic diagrams each showing an example of a screen displayed on the display panel 15 of the user terminal device 10. FIG. 24A shows a Top screen 101. The Top screen 101 is a screen for a user to search for a use requirement. In the Top screen 101, a use date, a departure time, a destination, the number of users, the purpose of use, etc., can be set as the use requirement. When a “vehicle preference setting” icon 102 is operated, a vehicle preference setting screen 111 shown in FIG. 24B is displayed. When a “battery preference setting” icon 103 is operated, a battery preference setting screen 121 shown in FIG. 24C is displayed. When setting of the use requirement is ended and a “search” icon 104 is operated, a plan selection screen 131 shown in FIG. 24D is displayed.

As shown in FIG. 24B, in the vehicle preference setting screen 111, “random”, or a vehicle model, a model year, a body color (vehicle body color), a capacity, a use fee, etc., can be set. When a “back” icon 113 is operated, the set content can be cleared and a return can be made to the Top screen 101. When a “decide” icon 112 is operated, the set content can be reflected and a return can be made to the Top screen 101.

As shown in FIG. 24C, in the battery preference setting screen 121, “random”, or cost precedence, traveling time precedence, etc., can be set. When cost precedence is set, for example, it can be set as a use requirement that an inexpensive battery is acceptable. In addition, when traveling time precedence is set, a battery that has a small degree of deterioration close to that of a new product can be set as a use requirement. When a “use battery selection” icon 122 is operated, a use battery selection screen 141 shown in FIG. 24E is displayed. When an “entrusted battery operation results” icon 123 is operated, an entrusted battery operation results screen 151 shown in FIG. 24F is displayed. When a “back” icon 125 is operated, the set content can be cleared and a return can be made to the Top screen 101. When a “decide” icon 124 is operated, the set content can be reflected and a return can be made to the Top screen 101.

As shown in FIG. 24E, in the use battery selection screen 141, which of owned batteries to select can be set. The owned batteries refer to batteries that are physically owned by the user for private use such as use at home or are used as a household power supply or for a private electric car or the like. In addition, in the use battery selection screen 141, which of entrusted batteries to select can be set. The entrusted batteries refer to batteries entrusted to the battery asset operation service provider. In the example of FIG. 24E, the current values are also shown. When a “back” icon 143 is operated, the set content can be cleared and a return can be made to the battery preference setting screen 121. When a “decide” icon 142 is operated, the set content can be reflected and a return can be made to the battery preference setting screen 121.

When the whole family goes out, only the minimum required batteries among the owned batteries can be left at home as a backup, and the other batteries can be used for a vehicle to be rented. In addition, if the batteries to be mounted to the vehicle to be rented cannot be covered by the owned batteries and the entrusted batteries, a battery selection condition is decided according to this situation, and the required number of batteries are selected and provided to the user.

As shown in FIG. 24D, in the plan selection screen 131, generated rental information is displayed on the basis of the use requirement set by the user. In the example of FIG. 24D, a use date, a vehicle model, a fee, a battery, etc., are displayed as a candidate 1. In addition, by operating a “candidate 2” icon 132 or a “candidate 3” icon 133, another candidate can be displayed. By operating a “decide” icon 134, a payment screen which is not shown can be displayed.

As shown in FIG. 24F, in the entrusted battery operation results screen 151, operation results such as valuation, quantity, received distribution, investment amount, and operation profit/loss can be displayed. By operating a “graph display” icon 152, a time-series graph of the operation results can be displayed. When a “back” icon 154 is operated, the set content can be cleared and a return can be made to the battery preference setting screen 121. When a “decide” icon 153 is operated, the set content can be reflected and a return can be made to the battery preference setting screen 121.

As described above, the display unit 16 displays a use requirement regarding the use of a vehicle equipped with a battery, on the display panel 15. The use requirement may be inputted by the user, or may be selected from the displayed information. When a search operation based on the displayed use information is accepted, the display unit 16 displays rental information regarding objects including at least either a battery or a vehicle to be rented out to the user.

Accordingly, when the user merely inputs or selects a use requirement, at least either a battery or a vehicle that meets the use requirement is displayed, so that a vehicle or a battery that matches the user's request can be easily selected.

The display unit 16 displays the vehicle preference setting screen 111 (vehicle setting screen) for setting a user's preference for a vehicle to be rented out to the user. The user's preference for a vehicle includes, for example, a vehicle model, a model year, a vehicle body color, a capacity, a use fee, etc. Accordingly, a vehicle that matches the user's request can be easily selected.

The display unit 16 displays the battery preference setting screen 121 (secondary battery setting screen) for setting a user's preference for a battery to be rented out to the user. The user's preference for a battery includes, for example, cost precedence, traveling time precedence, etc. Accordingly, a battery that matches the user's request can be easily selected.

The display unit 16 displays the use battery selection screen 141 (selection screen) for selecting a battery to be mounted to a vehicle, from among a plurality of batteries owned by the user. For battery selection, for example, a battery owned by the user can be selected, or an entrusted battery can be selected. In addition, it is possible to decide which location (for example, entrance, indoor, etc.) of a used battery to be selected from among the owned batteries. Moreover, it is possible to decide which current value of a battery to be selected from among the entrusted batteries. Accordingly, a battery that matches the user's request can be easily selected.

Next, a method for preventing unauthorized use of a battery or a vehicle will be described.

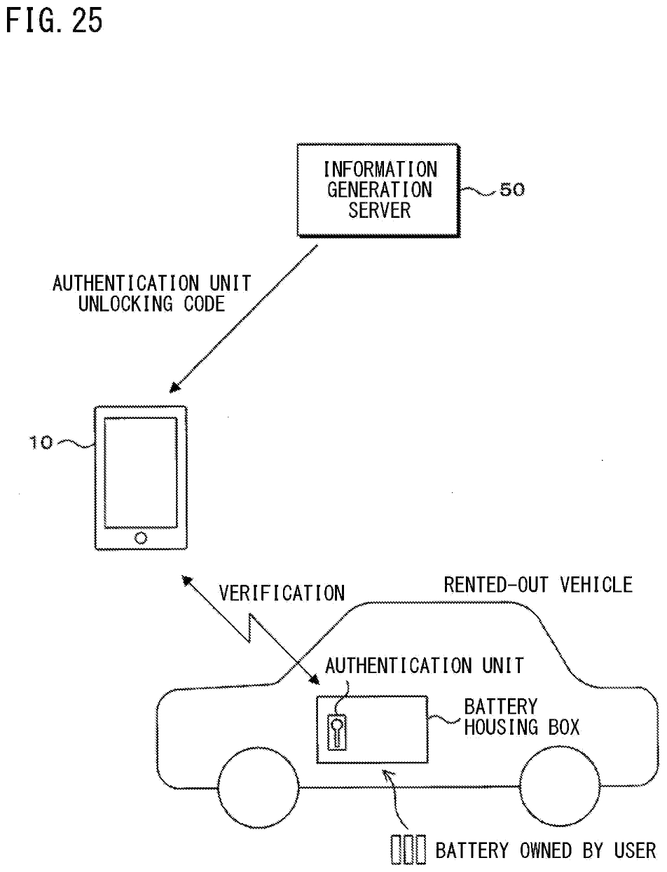

FIG. 25 is a schematic diagram showing an example of battery authentication by the information generation server 50. As shown in FIG. 25, a rented-out vehicle includes a battery housing box, and a battery adapted to the vehicle can be housed therein. The battery housing box may have a structure capable of restricting attachment/detachment of a battery, or may cover the entire battery in a state where the battery is housed therein, or a part of the battery may be exposed therefrom. An authentication unit with a lock is fixed to the battery storage box. By opening the lock of the authentication unit, the battery is allowed to be attached or detached.

The information generation server 50 transmits an authentication unit unlocking code to the user terminal device 10. When the user carries the user terminal device 10 and approaches the vehicle, verification is performed through short-range wireless communication between the user terminal device 10 and the authentication unit, and the authentication unit is unlocked. Accordingly, the user can mount their own battery to the rented-out vehicle. It should be noted that a dedicated application required for an authentication process can be installed in advance in the user terminal device 10. The unlocking may be performed by displaying the unlocking code on the display panel 15 of the user terminal device 10.

As described above, the communication unit 52 transmits key information for the lock to the user terminal device 10 in order to allow the lock to be opened when mounting a battery to a vehicle (for example, vehicle to be rented-out). The user terminal device 10 receives the key information. When the user carries the user terminal device 10 that has received the key information, and approaches the lock, the lock can be opened, allowing the battery to be mounted to the vehicle. Accordingly, unauthorized use of the battery or the vehicle can be prevented.

In the above example, the sharing service coordinator may provide authentication information to the vehicle sharing service provider, and the vehicle sharing service provider may deliver the vehicle directly to the user.

Although not shown, the following may be adopted. Specifically, a chip in which a serial number (identification number) is recorded may be incorporated into (integrated with) each of batteries owned by users, and the sharing service coordinator may register the serial numbers (identification numbers) of batteries, which are permitted to be used, in a battery control unit or a battery security management unit of a rented-out vehicle at the time of shipment of the vehicle, whereby only the registered batteries may be allowed to be used.

That is, the control unit 51 has a function as an identification information acquisition unit, and acquires identification information of a battery to be mounted to a vehicle. For example, a chip including identification information (for example, serial number, etc.) is integrated with a battery owned by a user.

The control unit 51 has a function as an output unit, and outputs verification information corresponding to the acquired identification information, to a verification unit (for example, battery control unit, battery security management unit, or the like) provided in the vehicle (for example, vehicle to be rented out), in order to register the verification information in the verification unit. For example, when shipping the vehicle to be rented out, the verification information is registered in the verification unit of the vehicle. That is, verification information for verifying a battery that is permitted to be used is registered in the vehicle in advance. Accordingly, unauthorized use of the vehicle or the battery can be prevented.

The information generation server 50 of the present embodiment can also be realized by using a general purpose computer including a CPU (processor), a RAM (memory), etc. That is, a storage medium having stored therein a computer program defining the procedure of the processes as shown in FIG. 11, FIG. 12, FIG. 16, FIG. 17, FIG. 19, and FIG. 20 is read by a storage medium reading device provided in the computer, and the read computer program is loaded to the RAM (memory) and executed by the CPU (processor), whereby the information generation server 50 can be realized on the computer.

According to the present embodiment, it is possible to provide a mechanism that allows vehicles (EV main bodies) and batteries to be shared independently and easily. Accordingly, it is not necessary to produce the same number of expensive batteries as that of EVs, and the prices of EV main bodies (having no batteries incorporated therein) can be reduced, so that EV main bodies can be mass-produced. In addition, it is possible to promote the spread of vehicle sharing, so that it is possible to eliminate the shortage of parking lots that occurs especially in urban areas. Moreover, with the spread of battery sharing, it is possible to mount a battery on a used EV body, so that it is possible to suppress a drop in the prices of EVs in the used car market and maintain the prices.

According to the present embodiment, a user does not need to individually purchase and own an EV, and can use an EV at a lower cost than the purchase/maintenance cost, by using a sharing service. In addition, by using a sharing service coordination service, it is possible to easily find a configuration that meets the user's own use requirement. Moreover, when the standardization of batteries progresses and it becomes possible to use batteries for both home and EV, it becomes possible to operate the batteries owned by the user, in a combination that gives the optimum cost.

The disclosed embodiments are illustrative in all aspects and should not be recognized as being restrictive. The scope of the present disclosure is defined by the scope of the claims rather than the above description, and is intended to include meaning equivalent to the scope of the claims and all modifications within the scope.

### (Additional Note 1)

A rental information generation device including a processor, wherein
the processor is configured to:
   acquire requirement information of a user regarding use of an electric vehicle equipped with a secondary battery;
   acquire stock information of objects including at least either one of a secondary battery and an electric vehicle;
   decide an object selection condition on the basis of the acquired requirement information and stock information; and
   generate rental information regarding an object to be rented out to the user on the basis of the decided selection condition.
      (Additional note 2)

A user terminal device including a display panel and a processor, wherein
the processor is configured to:
   display requirement information regarding use of an electric vehicle equipped with a secondary battery, on the display panel;
   accept a search operation based on the displayed requirement information; and
   when the search operation is accepted, display rental information regarding objects including at least either one of a secondary battery and an electric vehicle to be rented out to a user.

### REFERENCE SIGNS LIST

1 communication network

10 user terminal device

11 control unit

12 communication unit

13 operation unit

14 storage unit

15 display panel

16 display unit

20 battery information management server

21 control unit

22 communication unit

23 battery management information DB

30 battery stock management server

40 vehicle stock management server

50 information generation server

51 control unit

52 communication unit

53 decision unit

54 rental information generation unit

55 storage unit

56 consumption estimation unit

57 route estimation unit

58 charging plan generation unit

59 determination unit

60 battery state estimation unit

100 battery operation server

1. A rental information generation device comprising:
a processor configured with a program to perform operations comprising:
operation as a requirement information acquisition unit configured to acquire requirement information of a user regarding use of an electric vehicle equipped with a secondary battery;
operation as a stock information acquisition unit configured to acquire stock information of objects including at least either one of a secondary battery and an electric vehicle;
operation as a decision unit configured to decide an object selection condition on the basis of the acquired requirement information and stock information; and
operation as a generation unit configured to generate rental information regarding an object to be rented out to the user on the basis of the decided selection condition.

2. The rental information generation device according to claim 1, wherein the operations further comprises operation as possession information acquisition unit configured to acquire vehicle information of an electric vehicle owned by the user, wherein
the stock information includes secondary battery stock information,
the selection condition includes a secondary battery selection condition decided on the basis of the requirement information, and the acquired vehicle information and secondary battery stock information, and
the rental information includes rental information regarding a secondary battery to be rented out to the user.

3. The rental information generation device according to claim 1, wherein the operations further comprises operation as a possession information acquisition unit configured to acquire battery information of a secondary battery owned by the user, wherein
the stock information includes electric vehicle stock information,
the selection condition includes an electric vehicle selection condition decided on the basis of the requirement information, and the acquired battery information and electric vehicle stock information, and
the rental information includes rental information regarding an electric vehicle to be rented out to the user.

4. The rental information generation device according to claim 1, wherein
the stock information includes secondary battery and electric vehicle stock information,
the selection condition includes secondary battery and electric vehicle selection conditions decided on the basis of the requirement information, and the acquired secondary battery and electric vehicle stock information, and
the rental information includes rental information regarding a secondary battery and an electric vehicle to be rented out to the user.

5. The rental information generation device according to claim 4, wherein the secondary battery and electric vehicle selection conditions include a selection condition for a combination of a secondary battery and an electric vehicle decided on the basis of the requirement information, and the acquired secondary battery and electric vehicle stock information.

6. The rental information generation device according to claim 1, wherein
the requirement information includes a use date of an electric vehicle and a destination,
the operations further comprises operation as a route estimation unit configured to estimate a traveling route on the basis of the acquired use date and destination, and
the selection condition is decided on the basis of the estimated traveling route.

7. The rental information generation device according to claim 6, wherein the operations further comprises:
operation as a consumption estimation unit configured to estimate a power consumption of a secondary battery on the basis of the acquired requirement information and the estimated traveling route;
operation as a specific information acquisition unit configured to acquire specific information including an SOC of the secondary battery; and
operation as a charging plan generation unit configured to generate a charging plan for the secondary battery on the basis of the estimated power consumption and the acquired specific information.

8. The rental information generation device according to claim 7, wherein, when a voltage difference between a plurality of secondary batteries is larger than a predetermined threshold, the charging plan generated by the charging plan generation unit includes a charging plan that equalizes voltages of the plurality of secondary batteries.

9. The rental information generation device according to claim 6, wherein the operations further comprises:
operation as a consumption estimation unit configured to estimate a power consumption of a secondary battery on the basis of the acquired requirement information and the estimated traveling route; and
operation as a necessity determination unit configured to determine whether charging or replacement of the secondary battery in a middle of the traveling route is necessary, on the basis of the estimated power consumption.

10. The rental information generation device according to claim 1, wherein the operations further comprises operation as a condition acquisition unit configured to acquire a condition regarding operation of a secondary battery owned by another user different from the user, wherein
the rental information includes rental information regarding the secondary battery to be operated on the basis of the condition.

11. The rental information generation device according to claim 10, wherein the condition includes a first condition that requires a permission of the other user each time the secondary battery is rented out, a second condition that does not require a permission of the other user, and a third condition that does not permit the secondary battery to be rented out.

12. The rental information generation device according to claim 1, wherein the operations further comprises operation as a transmission unit configured to transmit key information for a lock to a user terminal device in order to allow the lock to be opened when mounting a secondary battery to an electric vehicle.

13. The rental information generation device according to claim 1, wherein the operations further comprises:
operation as an identification information acquisition unit configured to acquire identification information of a secondary battery to be mounted to an electric vehicle; and
operation as an output unit configured to output verification information corresponding to the acquired identification information, to a verification unit provided in the electric vehicle, in order to register the verification information in the verification unit.

14. A secondary-battery management device comprising a processor configured with a program to perform operations comprising operation as a provision unit configured to provide specific information of a managed secondary battery to the rental information generation device according to claim 1.

15. The secondary-battery management device according to claim 14, wherein the operations further comprises an acquisition unit configured to acquire specific information of a secondary battery owned by a user.

16. A user terminal device including a display panel, the user terminal device comprising:
a processor configured with a program to perform operations comprising:
operation as a display unit configured to display requirement information regarding use of an electric vehicle equipped with a secondary battery, on the display panel; and
operation as an acceptance unit configured to accept a search operation based on the displayed requirement information, wherein
when the acceptance unit accepts the search operation, the display unit displays rental information regarding objects including at least either one of a secondary battery and an electric vehicle to be rented out to a user.

17. The user terminal device according to claim 16, wherein the display unit displays an electric vehicle setting screen for setting a user's preference for an electric vehicle to be rented out to the user.

18. The user terminal device according to claim 16, wherein the display unit displays a secondary battery setting screen for setting a user's preference for a secondary battery to be rented out to the user.

19. The user terminal device according to claim 1, wherein the display unit displays a selection screen for selecting a secondary battery to be mounted to an electric vehicle, from among a plurality of secondary batteries owned by the user.

20. A non-transitory computer readable storage medium storing a computer program for causing a computer to execute:
a process of acquiring requirement information of a user regarding use of an electric vehicle equipped with a secondary battery;
a process of acquiring stock information of objects including at least either one of a secondary battery and an electric vehicle;
a process of deciding an object selection condition on the basis of the acquired requirement information and stock information; and
a process of generating rental information regarding an object to be rented out to the user on the basis of the decided selection condition.

21. A non-transitory computer readable storage medium storing a computer program for causing a computer to execute:
a process of displaying requirement information regarding use of an electric vehicle equipped with a secondary battery, on a display panel;
a process of accepting a search operation based on the displayed requirement information; and
a process of, when the search operation is accepted, displaying rental information regarding objects including at least either one of a secondary battery and an electric vehicle to be rented out to a user.

22. A rental information generation method comprising:
acquiring requirement information of a user regarding use of an electric vehicle equipped with a secondary battery;
acquiring stock information of objects including at least either one of a secondary battery and an electric vehicle;
deciding an object selection condition on the basis of the acquired requirement information and stock information; and
generating rental information regarding an object to be rented out to the user on the basis of the decided selection condition.
